(19) United States
(12) Patent Application Publication
(10) Pub. No.: US 2026/0230172 A1
(43) Pub. Date: Aug. 6, 2026

(54) METHODS, DEVICES, COMPUTER READABLE MEDIUM, APPARATUS AND COMUNTER PROGRAM PRODUCT FOR LOCATION BASED COMMUNICATION

(71) Applicant: Huawei Technologies Co., Ltd., Shenzhen (CN)

(72) Inventors: Aman Jassal, Stittsville (CA); Amine Maaref, Ottawa (CA); Jianglei Ma, Ottawa (CA)

(21) Appl. No.: 19/634,963

(22) Filed: Mar. 31, 2026

Related U.S. Application Data
(63) Continuation of application No. PCT/CN2024/085403, filed on Apr. 2, 2024.
(60) Provisional application No. 63/588,144, filed on Oct. 5, 2023.

(51) Int. Cl. H04B 7/185

(52) U.S. Cl. CPC H04B 7/18513

(57) ABSTRACT

Example embodiments relate to location based communication. In a method, a terminal device obtains identity information specific to a geographic area among a plurality of geographic areas covered by a non-terrestrial network (NTN). Then, the terminal device receives a reference signal in the geographic area in accordance with the identity information.

### CROSS-REFERENCE TO RELATED APPLICATIONS

The present disclosure is a continuation of International Application No. PCT/CN2024/085403, filed on Apr. 2, 2024, which claims priority to U.S. Provisional Application No. 63/588,144, filed on Oct. 5, 2023, the entire contents of which are incorporated by reference herein.

### FIELD

Example embodiments of the present disclosure generally relate to the field of communications, and in particular, to methods, devices, a non-transitory computer readable medium, apparatus and computer program product for location based communication.

### BACKGROUND

With the development of communication technologies and the demand for accessing the network increasing, a non-terrestrial network (NTN) architecture has been introduced. Non-Terrestrial Networks (NTN) are networks or segments of networks that use airborne or space borne vehicles for transmission. These networks use satellites, drones, and other airborne vehicles to provide connectivity wirelessly to even the most remote areas on Earth. Therefore, NTN enables global access to services like mobile data, voice calls and messaging, regardless of geographical location or terrain. Generally, solutions in NTNs, which may cooperate with terrestrial networks (TN), to provide communications with acceptable cost (such as power consumption and/or complexity) are desired.

In addition, NTN has unique characteristics which are different from the typical TN, and the unique characteristics can be studied to enhance the NTN performance.

### SUMMARY

In general, example embodiments of the present disclosure provide a solution for location based communication, especially for the location based communication for NTN.

It is to be understood that the summary section is not intended to identify key or essential features of embodiments of the present disclosure, nor is it intended to be used to limit the scope of the present disclosure. Other features of the present disclosure will become easily comprehensible through the following description.

In a first aspect, there is provided a method implemented at a terminal device. In the method, the terminal device obtains identity information specific to a geographic area among a plurality of geographic areas covered by a non-terrestrial network (NTN). That is, in NTN, the identity information is configured for a fixed geographic area on Earth, rather than the current coverage area of a NTN device in NTN. Then, the terminal device receives a reference signal in the geographic area in accordance with the identity information. In this way, even if the current coverage area of a moving NTN is changed with the movement of the NTN device, the terminal device can still use the identity information specific to geographic area on Earth to receive the reference signal, without reconfirming identity information required to receive the reference signals. As such, the communicating complexity in NTN may be reduced.

In some implementations of the present disclosure, the identity information is comprised in geographic area information, and the geographic area information is a portion of an elementary file. The identity information indicates: a plurality of geographic area identities that identify the plurality of geographic areas, and a plurality of location-specific scrambling identity values corresponding to the plurality of geographic area identities. In this way, the identity information may be preconfigured to the terminal device by the elementary file in Subscriber Identity Module (USIM). In addition, the location-specific scrambling identity value can be retrieved by determining the corresponding geographic area identity which may be determined based on terminal device's location.

In some implementations of the present disclosure, the reference signal is scrambled with a location-specific scrambling identity value that corresponds to a geographic area identity identifying the geographic area. The reference signal may be received by: determining, a target geographic area identity from the plurality of geographic area identities, wherein the target geographic area identity identifies a target geographic area in which the terminal device is located; and receiving the reference signal using a location-specific scrambling identity value of the plurality of location-specific scrambling identity values which corresponds to the target geographic area identity. In this way, the NTN may be enabled to be “transparent” from the perspective of the terminal device. The terminal device may receive, detect, decode or measure the reference signal in NTN using the location-specific scrambling identity value which is determined based on the location of the terminal device, even if a coverage area of the previous serving NTN device changes. Moreover, the NTN devices may be grouped or clustered together such that they appear as just one network node as far as devices on the ground are concerned.

In some implementations of the present disclosure, the elementary file further comprises a field indicating a shape type of the geographic area, locations of vertexes of the geographic area, or both of them. In this way, the plurality of geographic areas on Earth can be configured finely.

In some implementations of the present disclosure, the identity information further comprises a number of symbols per slot, an index for a symbol, or both of them. In some implementations of the present disclosure, the elementary file further comprises timing reference information, and the timing reference information indicates reference time, a system frame number, a radio frame number, a slot number, a symbol number, or any combination of them. In this way, the identity information or the elementary file may further indicate the time domain structure for NTN communication.

In some implementations of the present disclosure, the identity information comprises a plurality of beam set identities, and a plurality of beam identities associated with a beam set identity of the plurality of beam set identities. In this way, the beams transmitted by NTN may be identified in association with the geographic area on Earth. Furthermore, with the beam set division, a same beam identification may be reused for different beam sets. As such, even if the terminal device cannot determine its location, the terminal device may receive, detect, decode or measure the reference signal in NTN by using a smaller number of identifications for the beams or beam sets compared to that each beam is assigned with a unique identification.

In some implementations of the present disclosure, the method further comprises: obtaining, in a connected-mode, a terminal device-specific scrambling identity of the terminal device. In some implementations of the present disclosure, the reference signal is scrambled with the terminal device-specific scrambling identity, and wherein receiving the reference signal comprises: receiving the reference signal using the terminal device-specific scrambling identity. In this way, the interference between terminal devices may be further avoided.

In some implementations of the present disclosure, a physical identity of a first beam is determined based on a first beam set identity of the plurality of beam set identities and a first beam identity of a first plurality of beam identities associated with the first beam set identity, a first beam set identified by the first beam set identity comprises the first beam, and the physical identity is used to identify the first beam at a physical layer. In this way, the beam transmitted by NTN may be identified in a “two-level” structure, in order to reduce the communication complexity in NTN. That is, it allows terminal devices to perform Initial Access with a reduced level of complexity. Moreover, by dissociating physical beam identities from the non-terrestrial (NT)-transmit and receive points (TRPs), the problem of triggering mobility procedures upon the beam going away can be solved, because different NT-TRPs (e.g. on the same orbit) may transmit beams using the same physical beam identity, which allows devices to continue the same physical beam identity and thus maintain its RRC connection.

In some implementations of the present disclosure, the reference signal comprises a primary synchronization signal (PSS) and a secondary synchronization signal (SSS), and wherein: the PSS transmitted via the first beam is determined based on the first beam set identity; and the SSS transmitted via the first beam is determined based on the first beam identity. In some implementations of the present disclosure, the reference signal comprises a PSS and a SSS, and wherein receiving the reference signal comprises: receiving the PSS using the plurality of beam set identities; and receiving the SSS using the plurality of beam identities. In some implementations of the present disclosure, the first beam comprises a transmit beam of the NTN. In this way, the terminal device may receive, detect, decode or measure the PSS and SSS using the beam identifications having the above two-level structure. As such, the complexity may be reduced.

In some implementations of the present disclosure, beams from the NTN are divided into a plurality of beam subsets. In these implementations, activated beams are hopped between the plurality of beam subsets, in order to mitigate the inter-beam interference. Additionally or alternatively, a beam subset of the plurality of beam subsets is associated with a geographic area identity identifying a geographic area. Additionally or alternatively, the beam subset is associated with a physical identity of a beam. In this way, the inter-beam interference may be reduced.

In some implementations of the present disclosure, the identity information comprises one or more virtual identities of one or more virtual NTN devices, and wherein a virtual NTN device of the one or more virtual NTN devices is formed by a set of NTN devices in the NTN. In this way, by means of the virtual identity, network transparency is enabled. That is, the virtual NT-TRPs' identities can be not changed, even if the NTN devices forming the virtual NTN device changed. As such, the communication complexity can be reduced.

In some implementations of the present disclosure, the reference signal is scrambled with a virtual identity of the one or more virtual identities, and wherein receiving the reference signal comprises: receiving the reference signal using the one or more virtual identities. In this way, if the virtual NT-TRPs' identities don't change, then as far as devices on the ground are concerned: they may continue to receive, detect and measure reference signals based on the scrambling identities that are using the virtual NT-TRP identity.

In some implementations of the present disclosure, a NTN device of the set of NTN devices acts as an array element of a virtual array for a virtual NTN. Additionally or alternatively, at least one member or the number of members in the set of NTN devices is changed over the time. In this way, the communication continuity can be ensured even if the actual serving NTN device changes.

In a second aspect, there is provided a method implemented at a NTN device. In the method, the NTN device transmits, based on identity information, a reference signal for a geographic area among a plurality of geographic areas covered by a non-terrestrial network (NTN), wherein the identity information is specific to the geographic area. That is, in NTN, the identity information may be configured for a fixed geographic area on Earth, rather than the current coverage area of a NTN device in NTN. In this way, even if the coverage area of a NTN is changed with the movement of the NTN device, the terminal device can still use the identity information specific to geographic area on Earth to receive the reference signal, without reconfirming identity information required to receive the reference signals. As such, the communicating complexity in NTN may be reduced.

In some implementations of the present disclosure, the identity information is comprised in geographic area information, and the geographic area information is a portion of an elementary file, and the identity information indicates: a plurality of geographic area identities that identify the plurality of geographic areas, and a plurality of location-specific scrambling identity values corresponding to the plurality of geographic area identities. In this way, the identity information may be preconfigured to the terminal device by the elementary file in Subscriber Identity Module (USIM). In addition, the location-specific scrambling identity value can be retrieved by determining the corresponding geographic area identity which may be determined based on terminal device's location.

In some implementations of the present disclosure, the reference signal is scrambled with a location-specific scrambling identity value that corresponds to a geographic area identity identifying the geographic area. In this way, the NTN may be enabled to be “transparent” from the perspective of the terminal device. As such, the terminal device may receive, detect, decode or measure the reference signal in NTN using the location-specific scrambling identity value which is determined based on the location of the terminal device, even if a coverage area of the previous serving NTN device changes. Moreover, the NTN devices may be grouped or clustered together such that they appear as just one network node as far as devices on the ground are concerned.

In some implementations of the present disclosure, the elementary file further comprises a field indicating a shape type of the geographic area, locations of vertexes of the geographic area, or both of them. In this way, the plurality of geographic areas on Earth can be configured finely.

In some implementations of the present disclosure, the geographic area information further comprises a number of symbols per slot, an index for a symbol, or both of them. In some implementations of the present disclosure, the elementary file further comprises timing reference information, and the timing reference information indicates reference time, a system frame number, a radio frame number, a slot number, a symbol number, or any combination of them. In this way, the identity information or the elementary file may further indicate the time domain structure for NTN communication.

In some implementations of the present disclosure, the identity information comprises a plurality of beam set identities, and a plurality of beam identities associated with a beam set identity of the plurality of beam set identities. In this way, the beams transmitted by NTN may be identified in association with the geographic area on Earth. Furthermore, with the beam set division, a same beam identification may be reused for different beam sets. As such, even if the terminal device cannot determine its location, the terminal device may receive, detect, decode or measure the reference signal in NTN by using a smaller number of identifications for the beams or beam sets compared to that each beam is assigned with a unique identification.

In some implementations of the present disclosure, the method further comprises: transmitting, to a terminal device in a connected-mode, a terminal device-specific scrambling identity of the terminal device. In some implementations of the present disclosure, the reference signal towards the terminal device is scrambled with the terminal device-specific scrambling identity. In this way, the interference between terminal devices may be further avoided.

In some implementations of the present disclosure, a physical identity of a first beam is determined based on a first beam set identity of the plurality of beam set identities and a first beam identity of a first plurality of beam identities associated with the first beam set identity, a first beam set identified by the first beam set identity comprises the first beam, and the physical identity is used by a terminal device to identify the first beam at a physical layer. In this way, the beam transmitted by NTN may be identified in a “two-level” structure, in order to reduce the communication complexity in NTN. That is, it allows terminal devices to perform Initial Access with a reduced level of complexity. Moreover, by dissociating physical beam identities from the non-terrestrial (NT)-transmit and receive points (TRPs), the problem of triggering mobility procedures upon the beam going away can be solved, because different NT-TRPs (e.g. on the same orbit) may transmit beams using the same physical beam identity, which allows devices to continue the same physical beam identity and thus maintain its RRC connection.

In some implementations of the present disclosure, the reference signal comprises a primary synchronization signal (PSS) and a secondary synchronization signal (SSS), and wherein: the PSS transmitted via the first beam is determined based on the first beam set identity; and the SSS transmitted via the first beam is determined based on the first beam identity. In some implementations of the present disclosure, the first beam comprises a transmit beam of the NTN. In this way, the terminal device may receive, detect, decode or measure the PSS and SSS using the beam identifications having the above two-level structure. As such, the complexity may be reduced.

In some implementations of the present disclosure, beams transmitted by the NTN are divided into a plurality of beam subsets. In these implementations, activated beams are hopped between the plurality of beam subsets, in order to mitigate the inter-beam interference. Additionally or alternatively, a beam subset of the plurality of beam subsets is associated with a geographic area identity. Additionally or alternatively, the beam subset is associated with a physical identity of a beam. In this way, the inter-beam interference may be reduced.

In some implementations of the present disclosure, the identity information comprises one or more virtual identities of one or more virtual non-terrestrial (NT) network devices, and wherein a virtual NTN device of the one or more virtual NTN devices is formed by a set of NTN devices in the NTN. In this way, by means of the virtual identity, network transparency is enabled. That is, the virtual NT-TRPs' identities can be not changed, even if the NTN devices forming the virtual NTN device changed. As such, the communication complexity can be reduced.

In some implementations of the present disclosure, the reference signal is scrambled with a virtual identity of the one or more virtual identities. In this way, if the virtual NT-TRPs' identities don't change, then as far as devices on the ground are concerned: they may continue to receive, detect and measure reference signals based on the scrambling identities that are using the virtual NT-TRP identity.

In some implementations of the present disclosure, the NTN device of the set of NTN devices acts as an array element of a virtual array for a virtual NTN. Additionally or alternatively, at least one member or the number of members in the set of NTN devices is changed over the time. In this way, the communication continuity can be ensured even if the actual serving NTN device changes.

In a third aspect, there is provided a terminal device. The terminal device comprises a transceiver and a processor communicatively coupled with the transceiver. The processor is configured to obtain identity information specific to a geographic area among a plurality of geographic areas covered by a non-terrestrial network (NTN). That is, in NTN, the identity information is configured for a fixed geographic area on Earth, rather than the current coverage area of a NTN device in NTN. Then, the processor is further configured to receive the reference signal in the geographic area in accordance with the identity information. In this way, even if the coverage area of a NTN is changed with the movement of the NTN device, the terminal device can still use the identity information specific to geographic area on Earth to receive the reference signal, without reconfirming identity information required to receive the reference signals. As such, the communicating complexity in NTN may be reduced.

In a fourth aspect, there is provided a NTN device. The NTN device comprises a transceiver and a processor communicatively coupled with the transceiver. The processor is configured to transmit, based on identity information, a reference signal for a geographic area among a plurality of geographic areas covered by a non-terrestrial network (NTN), wherein the identity information is specific to the geographic area. That is, in NTN, the identity information may be configured for a fixed geographic area on Earth, rather than the current coverage area of a NTN device in NTN. In this way, even if the coverage area of a NTN is changed with the movement of the NTN device, the terminal device can still use the identity information specific to geographic area on Earth to receive the reference signal, without reconfirming identity information required to receive the reference signals. As such, the communicating complexity in NTN may be reduced.

In a fifth aspect, there is provided a non-transitory computer readable medium comprising computer program stored thereon, the computer program, when executed on at least one processor, causing the at least one processor to perform the method of any one of the first aspect or second aspect.

In a sixth aspect, there is provided a chip comprising at least one processing circuit configured to perform the method of any one of the first aspect or second aspect.

In a seventh aspect, there is provided an apparatus comprising at least one processor configured to cause the apparatus to perform the method of any one of the first aspect or second aspect.

In an eighth aspect, there is provided a computer program product tangibly stored on a computer-readable medium and comprising computer-executable instructions which, when executed, cause an apparatus to perform the method of any one of the first aspect or second aspect.

### BRIEF DESCRIPTION OF THE DRAWINGS

Some example embodiments will now be described with reference to the accompanying drawings, in which:

FIG. 1A illustrates an example communication system in which some embodiments of the present disclosure can be implemented;

FIG. 1B illustrates an example communication system in which some embodiments of the present disclosure can be implemented;

FIG. 1C illustrates example devices in the example environments of FIG. 1A and FIG. 1B;

FIG. 1D illustrates example modules in the devices of the present disclosure;

FIG. 1E illustrates an example sensing management function (SMF) of the present disclosure;

FIGS. 2A to 2D illustrate example scenarios of communication architecture including NTN according to some embodiments of the present disclosure;

FIG. 3 illustrates a signaling process for location based communication according to some embodiments of the present disclosure;

FIG. 4A illustrates an example correspondence between a geographic area (identity, ID) and a location-specific scrambling identity according to some embodiments of the present disclosure;

FIG. 4B illustrates examples of shape types of the geographic area according to some embodiments of the present disclosure;

FIGS. 4C and 4D illustrate the example NTN device “transparency” from the perspective of the terminal devices in the case of location based communication according to some embodiments of the present disclosure;

FIG. 5A illustrates an example of massive beams transmitted from NTN devices in NTN according to some embodiments of the present disclosure;

FIG. 5B illustrates an example correspondence between a beam set identity, a beam identity of a beam in the beam set and a geographic area as well as a physical identity of the beam that can be determined based on the beam set identity and the beam identity according to some embodiments of the present disclosure;

FIG. 5C illustrates examples of beam sets of which each has a plurality of respective beams and corresponding covered geographic areas according to some embodiments of the present disclosure;

FIGS. 6A to 6D illustrate examples of virtual NT-TRPs formed by one or more actual NT-TRPs and virtual identities of the virtual NT-TRPs that are used for reference signals in a corresponding geographic area according to some embodiments of the present disclosure;

FIG. 7 illustrates an example of a terminal device-specific scrambling identity used to scramble the reference signals in the connected mode of a terminal device according to some embodiments of the present disclosure;

FIG. 8 illustrates a flowchart of an example method implemented at a terminal device according to some embodiments of the present disclosure;

FIG. 9 illustrates a flowchart of an example method implemented at a NTN device according to some embodiments of the present disclosure;

FIG. 10 is a block diagram of a device that may be used for implementing some embodiments of the present disclosure;

FIG. 11 is a schematic diagram of a structure of an apparatus in accordance with some embodiments of the present disclosure; and

FIG. 12 is a schematic diagram of a structure of an apparatus in accordance with some embodiments of the present disclosure.

Throughout the drawings, the same or similar reference numerals represent the same or similar elements.

### DETAILED DESCRIPTION

Principles of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments of the present disclosure described herein can be implemented in various manners other than the ones specifically described below.

In the following description and claims, unless defined otherwise, all technical and scientific terms used herein have the same meaning as commonly understood by one of ordinary skill in the art to which this disclosure belongs.

References in the present disclosure to “one embodiment”, “an embodiment”, “an example embodiment”, and the like indicate that the embodiment described may include a particular feature, structure, or characteristic, but it is not necessary that every embodiment includes the particular feature, structure, or characteristic. The term “another embodiment” is to be read as “at least one other embodiment.” Moreover, such phrases are not necessarily referring to the same embodiment. Further, when a particular feature, structure, or characteristic is described in connection with an embodiment, it is within the knowledge of one skilled in the art to adapt or modify such feature, structure, or characteristic in connection with other embodiments, whether or not such adaptations are explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms. Other definitions, explicit and implicit, may be included below.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In the following description and claims, unless defined otherwise, all technical and scientific terms used herein have the same meaning as commonly understood by one of ordinary skill in the art to which this disclosure belongs.

As used herein, the term “terminal device” refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, devices for vehicle to everything (V2X) communication, devices for Integrated Access and Backhaul (IAB), devices for Small Data Transmission (SDT), devices for mobility, devices for Multicast and Broadcast Services (MBS), devices for positioning, devices for dynamic/flexible duplexing in commercial networks, reduced capability (RedCap) devices, space-borne vehicles or air-borne vehicles in non-terrestrial networks (NTN) including satellites and High Altitude Platforms (HAPs) encompassed in Unmanned Aircraft Systems (UAS), extended Reality (XR) devices including different types of realities such as Augmented Reality (AR), Mixed Reality (MR) and Virtual Reality (VR), an unmanned aerial vehicle (UAV), a drone, devices on high speed train (HST), image capture devices such as digital cameras, sensors, gaming devices, music storage and playback devices, Internet-connected appliances, and the like. The terminal device may further include a “multicast/broadcast” feature to support public safety and/or mission critical applications. The terminal device may further include transparent IPv4/IPv6 multicast delivery such as for IPTV, smart TV, radio services, software delivery over wireless, group communications, and IoT applications. The terminal may incorporate a Subscriber Identity Module (SIM) or multiple SIMs, also known as Multi-SIM. The term “terminal device” can also be used interchangeably with variations of some of all of the preceding terms, such as a UE, a mobile station, a subscriber station, a mobile terminal, a user terminal, a wireless device, or a reduced capability terminal device.

As used herein, the term “network device” refers to a device which is capable of providing or hosting a cell or coverage area where terminal devices can communicate. Examples of a network device include, but are not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node or a pico node, a reconfigurable intelligent surface (RIS), network-controlled repeaters, and the like.

The terminal device or the network device may have artificial intelligence (AI) or machine learning (ML) capability. AI/ML generally refers to a model which has been trained from numerous collected data for a specific function, and can be used to predict some information. The terminal or the network device may function in several frequency ranges, e.g. FR1 (410 MHz-7125 MHz), FR2 (24.25 GHz to 71 GHz), 71 GHz to 114 GHz, and ranges of frequencies greater than 100 GHz, including Tera Hertz (THz) frequencies. The terminal or the network device can further function in licensed, unlicensed, or shared spectra. The terminal device may have multiple connections with multiple network devices, such as under a Multi-Radio Dual Connectivity (MR-DC) application scenario. The terminal device or the network device may be capable of advanced duplexing functions, such as full duplex, flexible duplex, and cross-division duplex (XDD) modes.

The network device may have functions or capabilities for network energy saving, self-organizing network (SON) automation, or minimization of drive tests (MDT) mechanisms. The terminal may have functions or capabilities for power saving.

The embodiments of the present disclosure may be performed in test equipment, e.g. a signal generator, a signal analyzer, a spectrum analyzer, a network analyzer, a test terminal device, a test network device, and a channel emulator.

The embodiments of the present disclosure may be performed according to communication protocols of any generation either currently known or to be developed in the future. Examples of these communication protocols include, but are not limited to, cellular protocols including the first generation (1G), the second generation (2G, 2.5G, 2.75G), the third generation (3G), the fourth generation (4G, sometimes known as “LTE”, 4.5G, sometimes known as “LTE Advanced” and “LTE Advanced Pro”), the fifth generation (5G, sometimes known as “NR”, 5.5G, 5G-Advanced), and the sixth generation (6G), as well as various generations of Wireless Fidelity (WiFi), and Ultra Wideband (UWB).

In one embodiment, the terminal device may be connected to a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. In another embodiment, the first RAT device is 5G network device and the second RAT device is a 6G network device. Information related to different RATs may be transmitted to the terminal device from at least one of the first network device and the second network device. In one embodiment, first information may be transmitted to the terminal device from the first network device and second information may be transmitted to the terminal device from the second network device directly or via the first network device. In one embodiment, information related to configuration for the terminal device, and configured by the second network device, may be transmitted from the second network device via the first network device. Information related to reconfiguration for the terminal device, and configured by the second network device, may be transmitted to the terminal device from the second network device directly or via the first network device.

In some examples, values, procedures, or apparatus may be referred to as “best,” “lowest,” “highest,” “minimum,” “maximum,” or the like. It will be appreciated that such descriptions are intended to indicate that a selection among many functional alternatives may be made; however, and such selections may be superlatives in some respects but need not be better, smaller, higher, or otherwise preferable to other selections in other respects.

In some embodiments of this disclosure, the term “NTN device” may refer to the device(s) acting as the “network device” in NTN. That is, the NTN device is capable of providing or hosting a cell or coverage area of NTN where terminal devices can communicate. Without any limitation, the NTN device may be carried on or may be satellites, drones, and other airborne vehicles. Examples of a NTN device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node or a pico node, a reconfigurable intelligent surface (RIS), network-controlled repeaters, and the like.

In some embodiments of this disclosure, the term “non-transparent design” or “transparent design” may relate to the NTN device behavior “seen” by the terminal devices in NTN. If the network design is referred to as the “non-transparent design”, it may refer to that every satellite is effectively seen by terminal devices, for example, by means of the physical identity (ID) of the satellite. In this case, the terminal device may be required to perform respective initial access and communication operations for individual NTN devices in the NTN. In turn, if the network design is referred to as the “transparent design”, the NTN devices may be seen as “relatively fixed” to the terminal devices compared to the non-transparent design, even if the NTN device is moving actually. In other words, in the transparent design, if the terminal device is maintained in a certain area, it seems that the same NTN device provided the network service from the terminal device's perspective.

In some embodiments of this disclosure, NTN described in this disclosure may be the whole communication network or a portion of the whole communication network without any limitation. For example, NTN may be combined with NT to provide network access for the terminal devices. Alternatively, NTN may individually provide network access for the terminal devices.

In some embodiments of this disclosure, the term “reference signal” may refer to predefined signals occupying specific resource elements within the uplink/downlink radio resources. There are several types of reference signals transmitted in different ways and intended to be used for different purposes by a receiving device. The reference signal may include, but not limited to, channel state information (CSI)-reference signal (RS), sounding reference signal (SRS), Phase-Tracking Reference Signals, demodulation reference signal (DM-RS), and so on.

In some embodiments, the term “geographic area” may refer to a fixed area on Earth surface. Only for discussion clarity, the terms “geographic area” and “coverage area” may be used interchangeably, without any limitation.

As mentioned above, NTN has unique characteristics which are different from the typical NT. The NTN device in NTN is in a mobile state in most cases. For example, either the satellites or the drones in NTNs may move at a high-speed relative to devices such as user equipment (UEs) operating within the NTN, which is different from the scenario between UE and ground-based base station. In addition, the distance between the UE and the satellites or the drones is also much longer than the distance between UE and ground-based base station. Thus, the coverage area or “physical” cell of a certain NTN device will move accordingly. In turn, from the perspective of the terminal device served by NTN, the served cell or coverage area is changed with time. As such, the terminal device may be required to frequently handle the handover between different cells provided by NTN devices, if the terminal device does not move following the NTN device. Accordingly, the complexity of accessing the network of the terminal device in NTN will be increased.

That is, in some network architecture, NTN is based on a “non-transparent” design in the sense that every satellite is effectively seen by devices such as UEs, IoT devices, cars, etc., as a serving cell. Furthermore, terminal devices should also be aware of the satellite's ephemeris as well as the satellite's position at any given time as the satellite explicitly broadcasts it within System Information Block 19 (SIB19) that is transmitted by satellites in order to assist devices such as UEs with assistance information for network access in NTN. Therefore, this results in a non-transparent radio access design which prevents smooth integration of transmit diversity schemes, multi-TRP transmission schemes and distributed satellite systems.

In an example situation of Low Earth Orbit (LEO) NTN access, satellites are constantly in movement and therefore are in line-of-sight to devices on the ground for a limited amount of time. Taking the “Star-link Constellation” as an example, a LEO satellite may be in line-of-sight of a given device on the ground for a duration in order of several minutes. As a result, the information that the satellite transmits or broadcasts to devices on the ground may become outdated within a few minutes and constantly needs to be updated in order for the satellite communication to be working (due to ever changing Timing Advance for Uplink synchronization, and the need to (re-) acquire Downlink synchronization). In this case, only to keep the communication link operational, signaling overhead between satellites and devices on the ground may be high. Moreover, LEO satellites typically use the fixed-beam model in order to transmit signals and channels towards devices on the ground. As mentioned above, this results in satellite beams “sliding” across the surface of Earth, which triggers mobility and handover procedures whenever devices are located at the edge between two beams. Mobility and handover procedures typically cause delays and interruptions as the RRC connection needs to be re-established upon entering the target cell, which hurts the overall user experience.

In view of the above, example embodiments of the present disclosure propose a solution for the location based communication for NTN. In this solution, a terminal device obtains identity information specific to a geographic area among a plurality of geographic areas covered by a non-terrestrial network (NTN). The geographic area here refers to a fixed area on Earth surface. That is, in NTN, the identity information is configured for a fixed geographic area on Earth, rather than the current coverage area of a NTN device in NTN. In some example embodiments of the disclosure, the identity information may include geographic area IDs, location-specific scrambling identity values corresponding the geographic area IDs. In addition or alternatively, the identity information may include a plurality of beam set identities, and a plurality of beam identities associated with a beam set identity of the plurality of beam set identities. These beams may be the transmit beam of NTN device. In addition or alternatively, the identity information may include one or more virtual identities of one or more virtual NTN devices, and a virtual NTN device of the one or more virtual NTN devices is formed by a set of NTN devices in the NTN. Then, the terminal device receives a reference signal in the geographic area in accordance with the identity information.

In this way, even if the coverage area of a NTN is changed with the movement of the NTN device, the terminal device can still use the identity information specific to geographic area on Earth to receive the reference signal, without reconfirming identity information required to receive the reference signals (if the previous serving NTN moves away). As such, the communicating complexity in NTN may be reduced. Thus, the NTN may be enabled to be “transparent” from the perspective of the terminal device. The NTN devices may be grouped, clustered or configured together such that they appear as just one network node as far as devices on the ground are concerned.

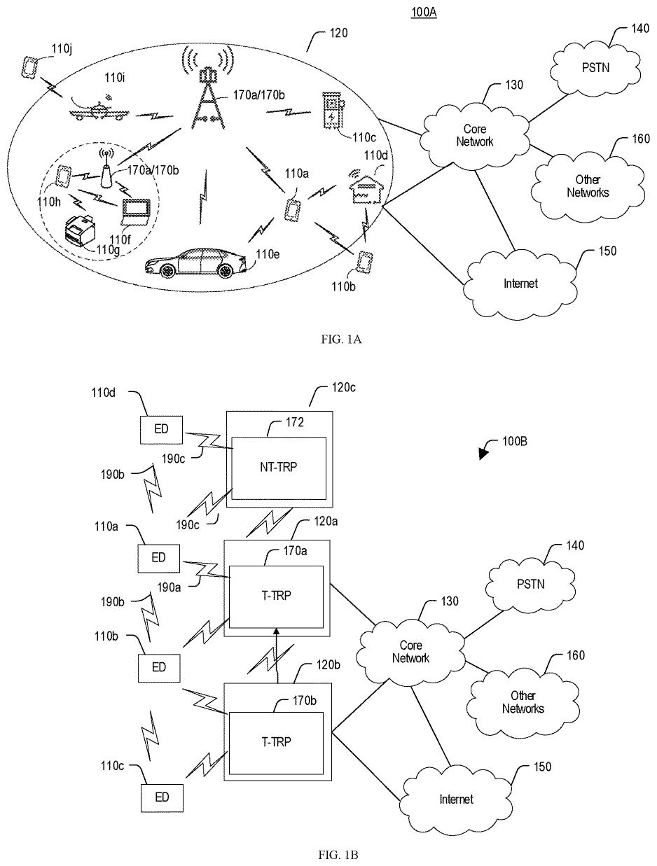

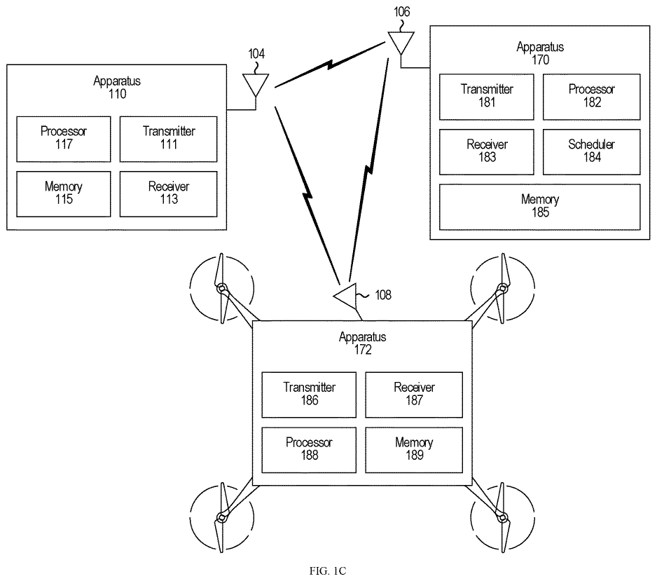

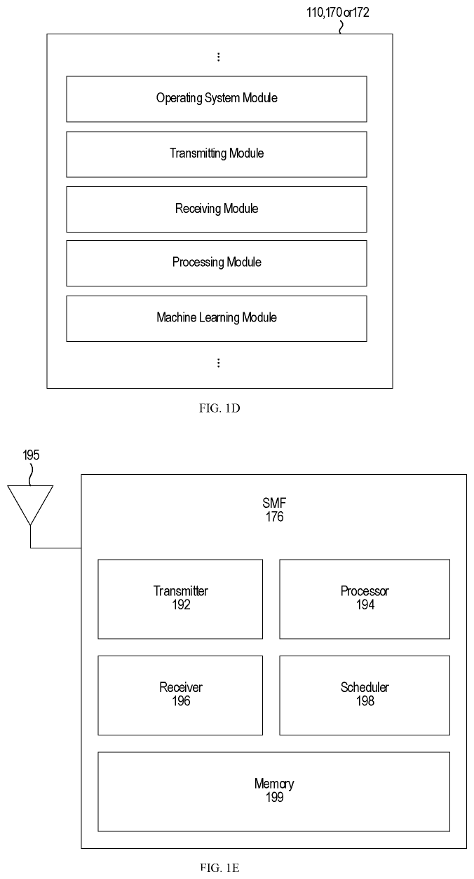

For illustrative purposes, principles and example embodiments of the present disclosure will be described below with reference to FIGS. 1A-12. However, it is to be noted that these embodiments are given to enable the person skilled in the art to understand inventive concepts of the present disclosure and implement the solution as proposed herein, and are not intended to limit the scope of the present application in any way to explicitly illustrated structures and combinations of features.

FIG. 1A illustrates an example communication system 100A in which some embodiments of the present disclosure can be implemented.

Referring to FIG. 1A, as an illustrative example without limitation, a simplified schematic illustration of a communication system is provided. The communication system 100A (which may be a wireless system) comprises a radio access network 120. The radio access network (RAN) 120 may be a next generation (e.g. sixth generation (6G) or later) radio access network, or a legacy (e.g. 5G, 4G, 3G or 2nd generation (2G)) radio access network. One or more communication electronic device (ED) 110a, 110b, 110c, 110d, 110e, 110f, 110g, 110h, 110i and 110j (generically referred to as 110) may be interconnected to one another or connected to one or more network nodes (170a, 170b, generically referred to as 170) in the radio access network 120. A core network 130 may be a part of the communication system and may be dependent or independent of the radio access technology used in the communication system 100A. The communication system 100A may also comprise a public switched telephone network (PSTN) 140, the internet 150, and other networks 160.

In general, the communication system 100A enables multiple wireless or wired elements to communicate data and other content. The communication system 100A may provide content, such as voice, data, video, and/or text, via broadcast, multicast, groupcast, unicast, etc. And the communication system 100A may provide a wide range of communication services and applications (such as earth monitoring, remote sensing, passive sensing and positioning, navigation and tracking, autonomous delivery and mobility, etc.) The services and/or applications may be mobile broadband (MBB) services, ultra-reliable low-latency communication (URLLC) services, or machine type communication (MTC) services.

The communication system 100A may operate by sharing resources, such as carrier spectrum bandwidth, between its constituent elements.

FIG. 1B illustrates an example communication system 100B in which some embodiments of the present disclosure can be implemented. The communication system 100B may be a more detailed example of the communication system 100A.

The communication system 100A in FIG. 1A may include a terrestrial communication system and/or a non-terrestrial communication system. The communication system 100A may provide a high degree of availability and robustness through a joint operation of a terrestrial communication system and a non-terrestrial communication system. For example, integrating a non-terrestrial communication system (or components thereof) into a terrestrial communication system can result in what may be considered a heterogeneous network comprising multiple layers. The heterogeneous network may achieve better overall performance through efficient multi-link joint operation, more flexible functionality sharing, and faster physical layer link switching between terrestrial networks and non-terrestrial networks.

The terrestrial communication system and the non-terrestrial communication system could be considered sub-systems of the communication system 100A.

Same as in the example shown in FIG. 1A, in the example shown in FIG. 1B, the communication system 100B may include ED 110a, 110b, 110c, 110d (generically referred to as ED 110), and RAN 120a, 120b. In addition, the communication system 100B may also include a non-terrestrial communication network 120c. The communication system 100B may also include one or more of a core network 130, a public switched telephone network (PSTN) 140, the Internet 150, and other networks 160. The RANs 120a, 120b include respective RAN nodes such as base stations (BSs) 170a, 170b, which may be generically referred to as terrestrial transmit and receive points (T-TRPs) 170a, 170b. In one implementation, the non-terrestrial communication network 120c includes a RAN node such as an access node (or base station) 172, which may be generically referred to as a non-terrestrial transmit and receive point (NT-TRP) 172. As may be surmised on the basis of similarity in reference numerals, the non-terrestrial communication network 120c may be considered to be a radio access network, with operational aspects in common with the RANS 120a, 120b. In another implementation, the non-terrestrial communication network 120c may include at least one non-terrestrial network (NTN) device and at least one corresponding terrestrial network device, wherein the at least one non-terrestrial network device works as a transport layer device and the at least one corresponding terrestrial network device works as a RAN node, which communicates with the ED via the non-terrestrial network device. In addition, there may be a NTN gateway in the ground (i.e., referred as a terrestrial network device) also as a transport layer device to communication with both the NTN device, and the RAN node communicates with the ED via the NTN device and the NTN gateway. In some implementations, the NTN gateway and the RAN node may be located in the same device.

Any ED 110 may be alternatively or additionally configured to interface, access, or communicate with any T-TRP 170a,170b and NT-TRP 172, the Internet 150, the core network 130, the PSTN 140, the other networks 160, or any combination of the preceding. In some examples, ED 110a may communicate an uplink (UL) and/or downlink (DL) transmission over a terrestrial air interface 190a with T-TRP 170a. In some examples, the EDs 110a, 110b, 110c, and 110d may also communicate directly with one another via one or more sidelink (SL) air interfaces 190b. In some examples, ED 110d may communicate an uplink and/or downlink transmission over a non-terrestrial air interface 190c with NT-TRP 172.

The air interfaces 190a and 190b may use similar communication technology, such as any suitable radio access technology. For example, the communication system 100B may implement one or more channel access methods, such as code division multiple access (CDMA), space division multiple access (SDMA), time division multiple access (TDMA), frequency division multiple access (FDMA), orthogonal FDMA (OFDMA), or single-carrier FDMA (SC-FDMA, also known as discrete Fourier transform spread OFDMA, DFT-s-OFDMA) in the air interfaces 190a and 190b. The air interfaces 190a and 190b may utilize other higher dimension signal spaces, which may involve a combination of orthogonal and/or non-orthogonal dimensions.

The non-terrestrial air interface 190c can enable communication between the ED 110d and one or multiple NT-TRPs 172 via a wireless link or simply a link. For some examples, the link is a dedicated connection for unicast transmission, a connection for broadcast transmission, or a connection between a group of EDs 110 and one or multiple NT-TRPs 172 for multicast transmission.

The RANs 120a and 120b are in communication with the core network 130 to provide the EDs 110a 110b, and 110c with various services such as voice, data, and other services. The RANs 120a and 120b and/or the core network 130 may be in direct or indirect communication with one or more other RANs (not shown), which may or may not be directly served by core network 130, and may or may not employ the same radio access technology as RAN 120a, RAN 120b or both. The core network 130 may also serve as a gateway access between (i) the RANs 120a and 120b or EDs 110a 110b, and 110c or both, and (ii) other networks (such as the PSTN 140, the Internet 150, and the other networks 160). In addition, some or all of the EDs 110a 110b, and 110c may include functionality for communicating with different wireless networks over different wireless links using different wireless technologies and/or protocols. Instead of wireless communication (or in addition thereto), the EDs 110a 110b, and 110c may communicate via wired communication channels to a service provider or switch (not shown), and to the Internet 150. PSTN 140 may include circuit switched telephone networks for providing plain old telephone service (POTS). Internet 150 may include a network of computers and subnets (intranets) or both, and incorporate protocols, such as Internet Protocol (IP), Transmission Control Protocol (TCP), User Datagram Protocol (UDP). EDs 110a 110b, and 110c may be multimode devices capable of operation according to multiple radio access technologies, and incorporate multiple transceivers necessary to support such.

In addition, the communication system 100B may comprise a sensing agent (not shown in the figure) to manage the sensed data from ED110 and or the T-TRP 170 and/or NT-TRP 172. In one implementation, the sensing agent is located in the T-TRP 170 and/or NT-TRP 172. In another implementation, the sensing agent is a separate node which has interface to communicate with the core network 130 and/or the RAN 120 (e.g., the T-TRP 170 and/or NT-TRP 172).

FIG. 1C illustrates an example of an apparatus 110 (which is shown as ED 110) wirelessly communicating with at least one of two apparatus (which are shown as T-TRP 170 and T-TRP 172) in a communication system, e.g., the communication system 100A or 100B, according to one embodiment. The apparatus 110 may be a UE (e.g., ED 110 in FIG. 1C). The apparatus 170 may be a terrestrial network device (e.g., T-TRP 170 as shown in FIG. 1C), and apparatus 172 may be a non-terrestrial network device (e.g., NT-TRP 172 as shown in FIG. 1C). However, this is not necessary. For example, the apparatus 170 may be a NT-TRP, and the apparatus 172 may be a T-TRP, both apparatuses 170 and 172 may be T-TRPs or NT-TRPs, according to present disclosure. In the following and as shown in FIG. 1C, the ED 110 as an example of the apparatus 110 is described, and T-TRP 170 as an example of apparatus 170 is described, and NT-TRP 172 as an example of apparatus 170 is described. Although only one ED 110, one T-TRP 170 and one NT-TRP 172, please note that the number of ED 110 could be one or more, and the number of T-TRP 170 and/or NT-TRP 172 could be one or more. For example, one ED110 may be served by only one T-TRP 170 (or one NT-TRP172), by more than one T-TRP 170, by more than one NT-TRP 172, or by one or more T-TRP 170 and one or more NT-TRP172.

The ED 110 is used to connect persons, objects, machines, etc. The ED 110 may be widely used in various scenarios including, for example, cellular communications, device-to-device (D2D), vehicle to everything (V2X), peer-to-peer (P2P), machine-to-machine (M2M), MTC, internet of things (IoT), virtual reality (VR), augmented reality (AR), mixed reality (MR), metaverse, digital twin, industrial control, self-driving, remote medical, smart grid, smart furniture, smart office, smart wearable, smart transportation, smart city, drones, robots, remote sensing, passive sensing, positioning, navigation and tracking, autonomous delivery and mobility, etc.

Each ED 110 represents any suitable end user device for wireless operation and may include such devices (or may be referred to but not limited to) as a user equipment/device (UE), a wireless transmit/receive unit (WTRU), a mobile station, a fixed or mobile subscriber unit, a cellular telephone, a station (STA), a MTC device, a personal digital assistant (PDA), a smartphone, a laptop, a computer, a tablet, a wireless sensor, a consumer electronics device, a smart book, a vehicle, a car, a truck, a bus, a train, or an IoT device, wearable devices (such as a watch, a pair of glasses, head mounted equipment, etc.), an industrial device, or an apparatus in (e.g. communication module, modem, or chip) or comprising the forgoing devices, among other possibilities. Future generation EDs 110 may be referred to using other terms. The base station 170a and 170b is a T-TRP and will hereafter be referred to as T-TRP 170. Also shown in FIG. 1C, a non-terrestrial (NT) device will hereafter be referred to as NT-TRP 172. Each ED 110 connected to T-TRP 170 and/or NT-TRP 172 can be dynamically or semi-statically turned-on (i.e., established, activated, or enabled), turned-off (i.e., released, deactivated, or disabled) and/or configured in response to one of more of: connection availability and connection necessity.

As shown in FIG. 1C, the ED 110 include at least one processor 117. Only one processor 117 is illustrated to avoid congestion in the drawing. The ED 110 may further include a transmitter 111 and a receiver 113 coupled to one or more antennas 104. Only one antenna 104 is illustrated to avoid congestion in the drawing. One, some, or all of the antennas 104 may alternatively be panels. The transmitter 111 and the receiver 113 may be integrated, e.g. as a transceiver. The transceiver is configured to modulate data or other content for transmission by at least one antenna 104 or network interface controller (NIC). The transceiver is also configured to demodulate data or other content received by the at least one antenna 104. Each transceiver includes any suitable structure for generating signals for wireless or wired transmission and/or processing signals received wirelessly or by wire. Each antenna 104 includes any suitable structure for transmitting and/or receiving wireless or wired signals. The ED 110 may include at least one memory 115. Only the transmitter 111, receiver 113, processor 117, memory 115, and antenna 104 is illustrated for simplicity, but the ED 110 may include one or more other components.

The memory 115 stores instructions. The memory 115 may also store data used, generated, or collected by the ED 110. For example, the memory 115 could store software instructions or modules configured to implement some or all of the functionality and/or embodiments described herein and that are executed by one or more processing unit(s) (e.g., a processor 117). Each memory 115 includes any suitable volatile and/or non-volatile storage and retrieval device(s). Any suitable type of memory may be used, such as random access memory (RAM), read only memory (ROM), hard disk, optical disc, subscriber identity module (SIM) card, memory stick, secure digital (SD) memory card, on-processor cache, and the like.

The ED 110 may further include one or more input/output devices (not shown) or interfaces (such as a wired interface to the Internet 150 in FIG. 1A). The input/output devices or interfaces permit interaction with a user or other devices in the network. Each input/output device or interface includes any suitable structure for providing information to or receiving information from a user, and/or for network interface communications. Suitable structures include, for example, a speaker, microphone, keypad, keyboard, display, touch screen, etc.

The processor 117 performs (or controlling the ED 110 to perform) operations described herein as being performed by the ED 110. As illustrated below and elsewhere in the present disclosure. For example, the processor 117 performs or controls the ED 110 to perform receiving transport blocks (TBs), using a resource for decoding of one of the received TBs, releasing the resource for decoding of another of the received TBs, and/or receiving configuration information configuring a resource. In details, the operation may include those operations related to preparing a transmission for uplink transmission to the NT-TRP 172 and/or the T-TRP 170; those operations related to processing downlink transmissions received from the NT-TRP 172 and/or the T-TRP 170; and those operations related to processing sidelink transmission to and from another ED 110. Processing operations related to preparing a transmission for uplink transmission may include operations such as encoding, modulating, transmit beamforming, and generating symbols for transmission. Processing operations related to processing downlink transmissions may include operations such as receive beamforming, demodulating and decoding received symbols. Processing operations related to processing sidelink transmissions may include operations such as transmit/receive beamforming, modulating/demodulating and encoding/decoding symbols. Depending upon the embodiment, a downlink transmission may be received by the receiver 113, possibly using receive beamforming, and the processor 117 may extract signaling from the downlink transmission (e.g. by detecting and/or decoding the signaling). An example of signaling may be a reference signal transmitted by the NT-TRP 172 and/or by the T-TRP 170. In some embodiments, the processor 117 implements the transmit beamforming and/or the receive beamforming based on the indication of beam direction, e.g. beam angle information (BAI), received from the T-TRP 170. In some embodiments, the processor 117 may perform operations relating to network access (e.g. initial access) and/or downlink synchronization, such as operations relating to detecting a synchronization sequence, decoding and obtaining the system information, etc. In some embodiments, the processor 117 may perform channel estimation, e.g. using a reference signal received from the NT-TRP 172 and/or from the T-TRP 170.

Although not illustrated, the processor 117 may form part of the transmitter 111 and/or part of the receiver 113. Although not illustrated, the memory 115 may form part of the processor 117.

The processor 117, the processing components of the transmitter 111, and the processing components of the receiver 113 may each be implemented by the same or different one or more processors that are configured to execute instructions stored in a memory (e.g. in the memory 115). Alternatively, some or all of the processor 117, the processing components of the transmitter 111, and the processing components of the receiver 113 may each be implemented using dedicated circuitry, such as a programmed field-programmable gate array (FPGA), an application-specific integrated circuit (ASIC), or a hardware accelerator such as a graphics processing unit (GPU) or an artificial intelligence (AI) accelerator.

In some implementations, the ED 110 may an apparatus (also called component) for example, communication module, modem, chip, or chipset, it includes at least one processor 117, and an interface or at least one pin. In this scenario, the transmitter 111 and receiver 113 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or another ED 110 may be referred as transmitting information to the interface or at least one pin, or as transmitting information to the NT-TRP 172 and/or the T-TRP 170 and/or another ED 110 via the interface or at least one pin, and receiving information from the NT-TRP 172 and/or the T-TRP 170 and/or another ED 110 may be referred as receiving information from the interface or at least one pin, or as receiving information from the NT-TRP 172 and/or the T-TRP 170 and/or another ED 110 via the interface or at least one pin. The information may include control signaling and/or data.

As shown in FIG. 1C, the T-TRP 170 include at least one processor 182. Only one processor 182 is illustrated to avoid congestion in the drawing. The T-TRP 170 may further include at least one transmitter 181 and at least one receiver 183 coupled to one or more antennas 106. Only one antenna 106 is illustrated to avoid congestion in the drawing. One, some, or all of the antennas 106 may alternatively be panels. The transmitter 181 and the receiver 183 may be integrated as a transceiver. The T-TRP 170 may further include at least one memory 185. The T-TRP 170 may further include scheduler 184. Only the transmitter 181, receiver 183, processor 182, memory 185, antenna 106 and scheduler 184 are illustrated for simplicity, but the T-TRP may include one or more other components.

The T-TRP 170 may be known by other names in some implementations, such as a base station, a base transceiver station (BTS), a radio base station, a network node, a network device, a device on the network side, a transmit/receive node, a Node B, an evolved NodeB (eNodeB or eNB), a Home eNodeB, a next Generation NodeB (gNB), a transmission point (TP), a site controller, an access point (AP), a wireless router, a relay station, a terrestrial node, a terrestrial network device, a terrestrial base station, a base band unit (BBU), a remote radio unit (RRU), an active antenna unit (AAU), a remote radio head (RRH), a central unit (CU), a distributed unit (DU), a positioning node, among other possibilities. The T-TRP 170 may be a macro base station (BS), a pico BS, a relay node, a donor node, or the like, or combinations thereof. The T-TRP 170 may refer to the forgoing devices or refer to apparatus (e.g. a communication module, a modem, or a chip) in the forgoing devices.

In some embodiments, the parts of the T-TRP 170 may be distributed. For example, some of the modules of the T-TRP 170 may be located remote from the equipment that houses the antennas 106 for the T-TRP 170, and may be coupled to the equipment that houses the antennas 106 over a communication link (not shown) sometimes known as front haul, such as common public radio interface (CPRI). Therefore, in some embodiments, the term T-TRP 170 may also refer to modules on the network side that perform processing operations, such as determining the location of the ED 110, resource allocation (scheduling), message generation, and encoding/decoding, and that are not necessarily part of the equipment that houses the antennas 106 of the T-TRP 170. The modules may also be coupled to other T-TRPs. In some embodiments, the T-TRP 170 may actually be a plurality of T-TRPs that are operating together to serve the ED 110, e.g. through the use of coordinated multipoint transmissions.

The processor 182 performs operations including those related to: preparing a transmission for downlink transmission to the ED 110, processing an uplink transmission received from the ED 110, preparing a transmission for backhaul transmission to the T-TRP 170 and/or NT-TRP 172, and processing a transmission received over backhaul from the T-TRP 170 and/or NT-TRP 172. Processing operations related to preparing a transmission for downlink or backhaul transmission may include operations such as encoding, modulating, precoding (e.g. multiple input multiple output (MIMO) precoding), transmit beamforming, and generating symbols for transmission. Processing operations related to processing received transmissions in the uplink or over backhaul may include operations such as receive beamforming, demodulating received symbols, and decoding received symbols. The processor 182 may also perform operations relating to network access (e.g. initial access) and/or downlink synchronization, such as generating the content of synchronization signal blocks (SSBs), generating the system information, etc. In some embodiments, the processor 182 also generates an indication of beam direction, e.g. BAI, which may be scheduled for transmission by a scheduler 184. The processor 182 performs other network-side processing operations described herein, such as determining the location of the ED 110, determining where to deploy the NT-TRP 172, etc. In some embodiments, the processor 182 may generate signaling, e.g. to configure one or more parameters of the ED 110 and/or one or more parameters of the NT-TRP 172. Any signaling generated by the processor 182 is sent by the transmitter 181.

The scheduler 184 may be coupled to the processor 182 or integrated in the processor 182. The scheduler 184 may be included within or operated separately from the T-TRP 170. The scheduler 184 may schedule uplink, downlink, sidelink, and/or backhaul transmissions, including issuing scheduling grants and/or configuring scheduling-free (e.g., “configured grant”) resources.

The memory 185 is configured to store information, and optionally data. The memory 185 stores instructions and data used, generated, or collected by the T-TRP 170. For example, the memory 185 could store software instructions or modules configured to implement some or all of the functionality and/or embodiments described herein and that are executed by the processor 182.

Although not illustrated, the processor 182 may form part of the transmitter 181 and/or part of the receiver 183. Also, although not illustrated, the processor 182 may implement the scheduler 184. Although not illustrated, the memory 185 may form part of the processor 182.

The processor 182, the scheduler 184, the processing components of the transmitter 181, and the processing components of the receiver 183 may each be implemented by the same or different one or more processors that are configured to execute instructions stored in a memory, e.g. in the memory 185. Alternatively, some or all of the processor 182, the scheduler 184, the processing components of the transmitter 181, and the processing components of the receiver 183 may be implemented using dedicated circuitry, such as a programmed FPGA, a hardware accelerator (e.g., a GPU or AI accelerator), or an ASIC.

When the T-TRP 170 is an apparatus (also called as component, for example, communication module, modem, chip, or chipset in a device, it includes at least one processor, and an interface or at least one pin. In this scenario, the transmitter 181 and receiver 183 may be replaced by the interface or at least one pin, wherein the interface or at least one pin is to connect the apparatus (e.g., chip) and other apparatus (e.g., chip, memory, or bus). Accordingly, the transmitting information to the NT-TRP 172 and/or the T-TRP 170 and/or ED 110 may be referred as transmitting information to the interface or at least one pin, and receiving information from the NT-TRP 172 and/or the T-TRP 170 and/or ED 110 may be referred as receiving information from the interface or at least one pin. The information may include control signaling and/or data.

Although the NT-TRP 172 is illustrated as a drone only as an example, the NT-TRP 172 may be implemented in any suitable non-terrestrial form, such as satellites and high altitude platforms, including international mobile telecommunication base stations and unmanned aerial vehicles, for example. Also, the NT-TRP 172 may be known by other names in some implementations, such as a non-terrestrial node, a non-terrestrial network device, or a non-terrestrial base station.

As shown in FIG. 1C, the NT-TRP 172 include at least one processor 188. Only one processor 188 is illustrated to avoid congestion in the drawing. The NT-TRP 172 may include a transmitter 186 and a receiver 187 coupled to one or more antennas 108. Only one antenna 108 is illustrated to avoid congestion in the drawing. One, some, or all of the antennas may alternatively be panels. The transmitter 186 and the receiver 187 may be integrated as a transceiver. The NT-TRP 172 may further include at least one memory 189. The NT-TRP 172 may further include scheduler. Only the transmitter 186, receiver 187, processor 188, memory 189, antenna 108 are illustrated for simplicity, but the NT-TRP may include one or more other components.

The NT-TRP 172 include a processor 188 for performing operations including those related to: preparing a transmission for downlink transmission to the ED 110, processing an uplink transmission received from the ED 110, preparing a transmission for backhaul transmission to T-TRP 170 and/or another NT-TRP 172, and processing a transmission received over backhaul from the T-TRP 170 and/or another NT-TRP 172. Processing operations related to preparing a transmission for downlink or backhaul transmission may include operations such as encoding, modulating, precoding (e.g. MIMO precoding), transmit beamforming, and generating symbols for transmission. Processing operations related to processing received transmissions in the uplink or over backhaul may include operations such as receive beamforming, demodulating received symbols, and decoding received symbols. In some embodiments, the processor 188 implements the transmit beamforming and/or receive beamforming based on beam direction information (e.g. BAI) received from the T-TRP 170. In some embodiments, the processor 188 may generate signaling, e.g. to configure one or more parameters of the ED 110. In some embodiments, the NT-TRP 172 implements physical layer processing, but does not implement higher layer functions such as functions at the medium access control (MAC) or radio link control (RLC) layer. As this is only an example, more generally, the NT-TRP 172 may implement higher layer functions in addition to physical layer processing.

The memory 189 is configured to store information and optionally data. The memory 189 stores instructions and data used, generated, or collected by the NT-TRP 172. For example, the memory 189 could store software instructions or modules configured to implement some or all of the functionality and/or embodiments described herein and that are executed by the processor 188.

Although not illustrated, the processor 188 may form part of the transmitter 186 and/or part of the receiver 187. Although not illustrated, the memory 189 may form part of the processor 188.

The processor 188, the processing components of the transmitter 186, and the processing components of the receiver 187 may each be implemented by the same or different one or more processors that are configured to execute instructions stored in a memory, e.g. in the memory 189. Alternatively, some or all of the processor 188, the processing components of the transmitter 186, and the processing components of the receiver 187 may be implemented using dedicated circuitry, such as a programmed FPGA, a hardware accelerator (e.g., a GPU or AI accelerator), or an ASIC. In some embodiments, the NT-TRP 172 may actually be a plurality of NT-TRPs that are operating together to serve the ED 110, e.g. through coordinated multipoint transmissions.

When the NT-TRP 172 is an apparatus (e.g. communication module, modem, chip, or chipset) in a device, it includes at least one processor, and an interface or at least one pin. In this scenario, the transmitter 186 and receiver 187 may be replaced by the interface or at least one pin, wherein the interface or at least one pin is to connect the apparatus (e.g., chip) and other apparatus (e.g., chip, memory, or bus). Accordingly, the transmitting information to the T-TRP 170 and/or another NT-TRP 172 and/or ED 110 may be referred as transmitting information to the interface or at least one pin, and receiving information from the T-TRP 170 and/or another NT-TRP 172 and/or ED 110 may be referred as receiving information from the interface or at least one pin. The information may include control signaling and/or data.

Note that “transmit/receive point (TRP)”, as used herein, may refer to a T-TRP or a NT-TRP. A T-TRP may alternatively be called a terrestrial network TRP (“TN TRP”) and a NT-TRP may alternatively be called a non-terrestrial network TRP (“NTN TRP”). The T-TRP 170, the NT-TRP 172, and/or the ED 110 may include other components, but these have been omitted for the sake of clarity.

Note that “signaling”, as used herein, may alternatively be called control signaling, control message, control information, or message for simplicity. Signaling between a BS (e.g., the network node 170) and a terminal or sensing device (e.g., ED 110), or signaling between different terminal or sensing device (e.g., between ED 110i and ED110j) may be carried in physical layer signaling (also called as dynamic signaling), which is transmitted in a physical layer control channel. For downlink the physical layer signaling may be known as downlink control information (DCI) which is transmitted in a physical downlink control channel (PDCCH). For uplink, the physical layer signaling may be known as uplink control information (UCI) which is transmitted in a physical uplink control channel (PUCCH). For sidelink, signaling between different terminal or sensing device (e.g., between ED 110i and ED110j) may be known as sidelink control information (SCI) which is transmitted in a physical sidlink control channel (PSCCH). Signaling may be carried in a higher-layer (e.g., higher than physical layer) signaling, which is transmitted in a physical layer data channel, e.g. in a physical downlink shared channel (PDSCH) for downlink signaling, in a physical uplink shared channel (PUSCH) for uplink signaling, and in a physical slidelink shared channel (PSSCH) for sidelink signaling. Higher-layer signaling may also called static signaling, or semi-static signaling. Higher-layer signaling may be radio resource control (RRC) protocol signaling or media access control-control element (MAC-CE) signaling. Signaling may be included in a combination of physical layer signaling and higher layer signaling.

It should be noted that in present disclosure, “information”, when different from “message”, may be carried in one single message, or be carried in more than one separate message.

One or more steps of the methods provided in this disclosure herein may be performed by corresponding units or modules, according to FIG. 1D. FIG. 1D illustrates units or modules in a device or apparatus, such as in the ED 110, in the T-TRP 170, or in the NT-TRP 172. For example, a signal may be transmitted by a transmitting unit or by a transmitting module. A signal may be received by a receiving unit or by a receiving module. A signal may be processed by a processing unit or a processing module. Other steps may be performed by an artificial intelligence (AI) or machine learning (ML) module. The respective units or modules may be implemented using hardware, one or more components or devices that execute software, or a combination thereof. For instance, one or more of the units or modules may be a circuit such as an integrated circuit. Examples of an integrated circuit includes a programmed FPGA, a GPU, or an ASIC. For instance, one or more of the units or modules may be logical such as a logical function performed by a circuit, by a portion of an integrated circuit, or by software instructions executed by a processor. It will be appreciated that where the modules are implemented using software for execution by a processor for example, the modules may be retrieved by a processor, in whole or part as needed, individually or together for processing, in single or multiple instances, and that the modules themselves may include instructions for further deployment and instantiation.

Additional details regarding the EDs 110, the T-TRP 170, and the NT-TRP 172 are known to those of skill in the art. As such, these details are omitted here.

The disclosure of the present invention is aimed at devices such as UEs, IoT devices, cars, etc. The type of network scenarios envisioned may include terrestrial TRPs such as base-stations and/or non-terrestrial TRPs such as drones, balloons, high-altitude platform stations (HAPS), satellites, and any such devices that support radio access technologies such as 5G NR, future 6G or other technologies.

FIG. 1E illustrates an example sensing management function (SMF) of the present disclosure.

As shown in FIG. 1E, the SMF 176, when implemented as a physically independent entity, includes at least one transmitter 192, at least one processor 194, one or more antennas 195, at least one receiver 196, a scheduler 198, and at least one memory 199. A transceiver, not shown, may be used instead of the transmitter 192 and receiver 196. The scheduler 198 may be coupled to the processor 194. The scheduler 198 may be included within or operated separately from the SMF 176. The processor 194 implements various processing operations of the SMF 176, such as signal coding, data processing, power control, input/output processing, or any other functionality. The processor 194 can also be configured to implement some or all of the functionality and/or embodiments described in more detail above. Each processor 194 includes any suitable processing or computing device configured to perform one or more operations. Each processor 194 could, for example, include a microprocessor, microcontroller, digital signal processor, field programmable gate array, or application specific integrated circuit.

A reference signal-based pose determination technique belongs to an “active” pose estimation paradigm. In an active pose estimation paradigm, the enquirer of pose information (i.e., the UE) takes part in process of determining the pose of the enquirer. The enquirer may transmit or receive (or both) a signal specific to pose determination process. Positioning techniques based on a global navigation satellite system (GNSS) such as Global Positioning System (GPS) are other examples of the active pose estimation paradigm.

In contrast, a sensing technique, based on radar for example, may be considered as belonging to a “passive” pose determination paradigm. In a passive pose determination paradigm, the target is oblivious to the pose determination process.

By integrating sensing and communications in one system, the system need not operate according to only a single paradigm. Thus, the combination of sensing-based techniques and reference signal-based techniques can yield enhanced pose determination.

The enhanced pose determination may, for example, include obtaining UE channel sub-space information, which is particularly useful for UE channel reconstruction at the sensing node, especially for a beam-based operation and communication. The UE channel sub-space is a subset of the entire algebraic space, defined over the spatial domain, in which the entire channel from the TP to the UE lies. Accordingly, the UE channel sub-space defines the TP-to-UE channel with very high accuracy. The signals transmitted over other sub-spaces result in a negligible contribution to the UE channel. Knowledge of the UE channel sub-space helps to reduce the effort needed for channel measurement at the UE and channel reconstruction at the network-side. Therefore, the combination of sensing-based techniques and reference signal-based techniques may enable the UE channel reconstruction with much less overhead as compared to traditional methods. Sub-space information can also facilitate sub-space based sensing to reduce sensing complexity and improve sensing accuracy.

In some example embodiments, the methods and devices of this disclosure are described by interaction and processing procedures between the user equipment (UE) and the base station (BS). Alternatively, the exchange of information and protocol flows in these procedures can also be performed by other network nodes described in FIG. 1A to 1E, for example, between ED 110 and TRP 170, between ED 110 and core network, between ED 110 and ED 110, between TRP 170 and TRP 170. The UE in the procedure described in the present disclosure may be replaced with a sensing node. The BS in the procedure described in the present disclosure may be replaced with a sensing coordinator. Sensing coordinators are nodes in a network that can assist in the sensing operation. These nodes can be stand-alone nodes dedicated to just sensing operations or may be other nodes (for example TRP 170, ED 110, or core network node as discussed above) performing sensing operations in parallel with communication operations.

Some embodiments of this disclosure are aimed at devices such as UEs, IoT devices, cars, etc. Without any limitation, although the solutions discussed with respect to NTN, the type of network scenarios envisioned may include terrestrial TRPs such as base-stations and/or non-terrestrial TRPs such as drones, balloons, high-altitude platform stations (HAPS), satellites, and any such devices that support radio access technologies such as 5G NR, future 6G or other technologies.

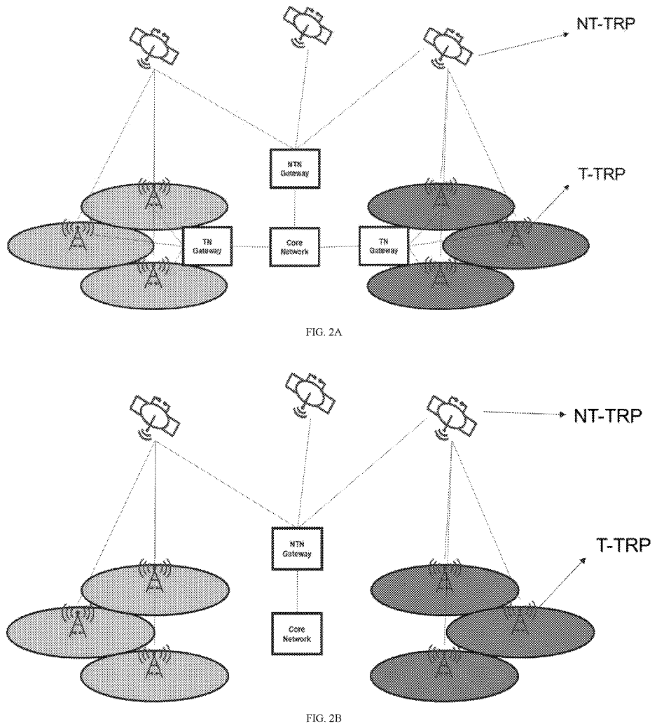

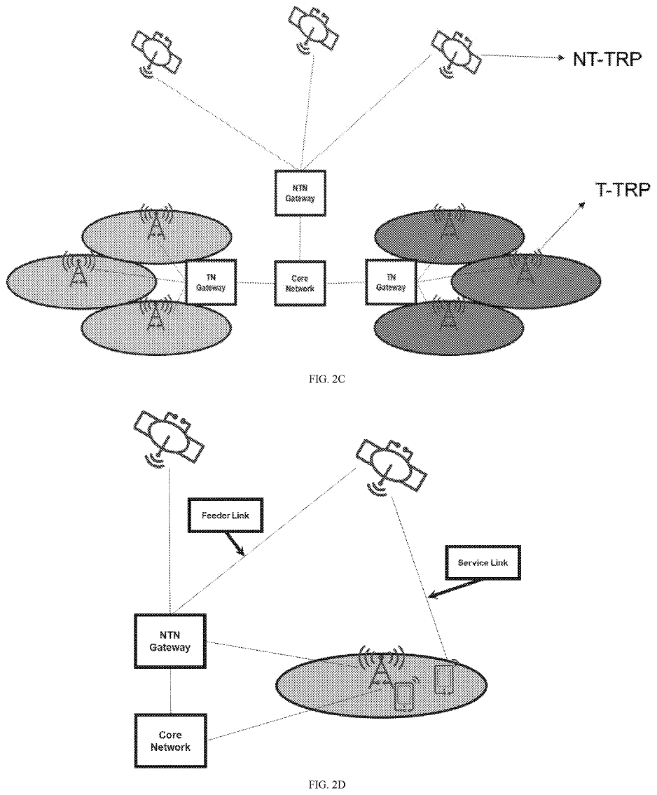

One possible scenario is that terrestrial TRPs are communicating with non-terrestrial TRPs that are part of a satellite constellation. A satellite constellation comprises a plurality of satellite orbits such that Earth is always provided with wireless coverage from the satellites, and each satellite orbits may have a plurality of satellites in it. Terrestrial TRPs may be connected to the core network through terrestrial gateways while satellite constellations may be connected to the core network through dedicated non-terrestrial gateways. Devices such as UEs may connect and communicate with a terrestrial TRP or with a non-terrestrial TRP, depending on the conditions of traffic load, radio link quality, congestion, and so on. Example scenarios are shown in the FIGS. 2A to 2D below.

FIGS. 2A to 2D illustrate example scenarios of communication architecture including NTN according to some embodiments of the present disclosure.

As shown in FIG. 2A, in some example embodiments of this disclosure, an optional scenario is that terrestrial TRPs may communicate with non-terrestrial TRPs that are part of a satellite constellation. A satellite constellation comprises a plurality of satellite orbits such that Earth is always provided with wireless coverage from the satellites, and each satellite orbits may have a plurality of satellites in it. Terrestrial TRPs (for example, the base stations) may be connected to the core network through terrestrial (TN) gateways while satellite constellations may be connected to the core network through dedicated non-terrestrial (NTN) gateways. Then, the terminal devices, such as UEs, may connect and communicate with a terrestrial TRP or with a non-terrestrial TRP, depending on the conditions of traffic load, radio link quality, congestion, and so on.

As shown in FIG. 2B, in some example embodiments of this disclosure, another optional scenario is that the satellite constellation effectively acts as the gateway for terrestrial TRPs on the ground. That is, the terrestrial TRP may communicate with satellites at first to communicate with the core network. Satellites in the satellite constellation may communicate with the core network through gateways (which may be also referred to as NTN gateway) located on the ground using a wireless link, while the gateways on the ground use a wired link (e.g. fiber optical link) to communicate with the core network. Terrestrial TRPs communicate with satellites using a wireless link and satellites communicate between each-other using free space optical links (using e.g. lasers). Devices such as UEs may connect and communicate with a terrestrial TRP or with a non-terrestrial TRP, depending on the conditions of traffic load, radio link quality, congestion, and so on.

As shown in FIG. 2C, in some example embodiments of this disclosure, a further optional scenario is that the non-terrestrial TRPs may communicate with terrestrial TRPs through the core network. Non-terrestrial TRPs may first communicate with dedicated non-terrestrial (NTN) gateways, which then communicate with the core network. The core network may then relay the any command (for example, the power saving commands) from non-terrestrial TRPs to terrestrial TRPs via dedicated terrestrial (TN) gateways. Devices such as UEs may connect and communicate with a terrestrial TRP or with a non-terrestrial TRP, depending on the conditions of traffic load, radio link quality, congestion, and so on.

For illustrative purposes, specific example embodiments will now be explained in greater detail in conjunction with the figures and above mentioned system, ED and TRP.

In traditional cellular systems such as 5G NR, the UE can receive, detect and measure reference signals such as SS/PBCH blocks and NZP-CSI-RS. Such reference signals are based on pseudo random noise (PRN) binary sequences such as Gold sequences and those sequences may be initialized using common or UE-specific scrambling identities. As an example, PSS and SSS sequences are initialized using the physical cell identity (PCI) value, which is a common scrambling identity. NZP-CSI-RS sequences are initialized using UE-specific scrambling identities, which are configured by the network to the UE.

5G NR Rel-17 introduces support for non-terrestrial networks by introducing several enhancements on the timing relationships for the Timing Advance, the reference timing for channel state information (CSI) resources, the transmission timing of DCIs scheduling PUSCH, the transmission timing of Random Access response carried by a PUSCH, the transmission timing of HARQ-ACK on a PUCCH.

In 5G NR Rel-17, NTN support was introduced allowing UEs to support DL/UL communication with satellites using the so-called “bent-pipe” scenario, where a ground station transmits signals towards satellites in space, and satellites reflect signals back to UEs on the ground. Dedicating signaling related to NTN was introduced in order to assist UEs with NTN operation. Higher-layer signaling such as RRC introduces signaling satellite ephemeris, satellite position, satellite signal polarization, timing advance offsets, satellite System Information Block (SIB), satellite epochs in order to support NTN operation. Other features that were introduced were the extension of hybrid automatic repeat request (HARQ) processes to 32 in order to accommodate for large propagation delay scenarios and the disabling of HARQ-ACK feedback.

5G NR Rel-17 also introduces a solution combining closed-loop and open-loop Timing Advance compensation, where the closed-loop part is controlled by the network and the open-loop part is carried out by the UE. The compensation from the UE may be based on the knowledge of the satellite's ephemeris (e.g. parameters such as the satellite's orbital angles).

In 5G NR Rel-18, NTN support was further enhanced to introduce Coverage enhancements for NTN, network-verified UE location, as well as support TN to NTN and NTN to NTN mobility scenarios. Satellites transmit multiple beams towards the ground and each beam may be associated with a given “physical cell identity”. in addition, the satellites transmit beams in a “fixed” manner, where “fixed” means that the satellite isn't steering its beams towards a given direction, instead the beams “slide” on the surface of Earth and thus appear to be “moving” from the perspective of devices on the ground.

The support introduced in 5G NR Rel-17 for NTN is based on a non-transparent design in the sense that every satellite is effectively seen by devices such as UEs, IoT devices, cars, etc., as a serving cell. Devices are also made aware of the satellite's ephemeris as well as the satellite's position at any given time as the satellite explicitly broadcasts it within System Information Block 19 (SIB19), which is transmitted by satellites in order to assist devices such as UEs with assistance information for NTN access (i.e., the UEs access to the NTN and to be served by the NTN). This results in a non-transparent radio access design which prevents smooth integration of transmit diversity schemes, multi-TRP transmission schemes and distributed satellite systems.

Other issues that stem from the application of legacy design in 5G NR to NTN scenarios are that of “PCI collision” and “PCI confusion”. PCI collision happens when two cells that are using the same PCI become adjacent neighbors. PCI confusion happens when two cells that are using the same PCI both become the adjacent neighbors of a given cell, i.e. the given cell sees two adjacent neighbor cells with the same PCI value. Both issues of “PCI collision” and “PCI confusion” may happen because satellites transmit beams towards the ground and are using a static association between beams and PCIs, and when two satellites on e.g. different orbits come close to each-other, their beam foot-prints may result in situations leading to e.g. PCI collision and/or PCI confusion.

In the case of Low Earth Orbit (LEO) NTN access, satellites are constantly in movement and therefore are in line-of-sight to devices on the ground for a limited amount of time. Taking the Starlink constellation as an example, a LEO satellite may be in line-of-sight of a given device on the ground for a duration in order of several minutes. As a result, any information that the satellite transmits or broadcasts to devices on the ground becomes outdated within a few minutes and constantly needs to be updated in order for the satellite communication to be working (due to ever changing Timing Advance for Uplink synchronization, and the need to (re-) acquire Downlink synchronization). This results in high signaling overhead between satellites and devices on the ground just to keep the communication link operational.

LEO satellites use the fixed-beam model in order to transmit signals and channels towards devices on the ground. This results in satellite beams “sliding” across the surface of Earth, which triggers mobility and handover procedures whenever devices are located at the edge between two beams. Mobility and handover procedures may cause delays and interruptions as the RRC connection needs to be re-established upon entering the target cell, which hurts the overall user experience.

A method is provided in this disclosure. The method includes that a UE in a certain location (area) obtains information about a location-specific scrambling identity, which is associated with reference signals that may be received, detected and measured in a certain area. The UE will measure the reference signals e.g. synchronization signals, and perform e.g. communications and/or Initial Access with the network based on the location-specific scrambling identities used to generate pseudo random-noise binary sequences for reference signals. Accordingly, the movements of the network node is transparent to the UE, and procedures such as mobility/handover will be decreased or even avoided. Hence, the signaling overhead will be decreased and the interruption/delay of the data transmission will be improved.

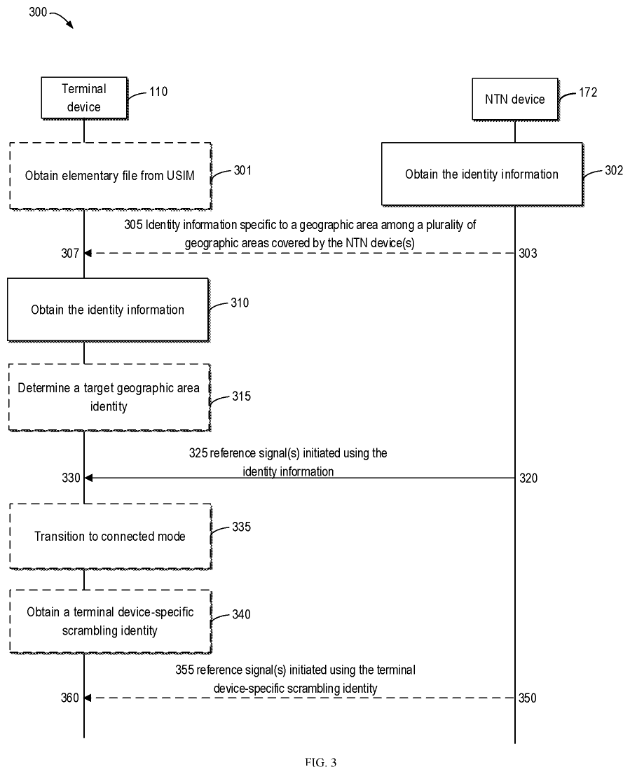

The example communication environment, communication system, terminal device, NTN device, electronic device, UE, BS, sensing node, NTN portion and TN portion, etc. of this disclosure have heretofore been discussed with reference to FIGS. 1A to 1E and FIGS. 2A to 2D. Methods and procedures in accordance with embodiments of this disclosure are further discussed with reference to FIGS. 3 to 7B.

FIG. 3 illustrates a signaling process 300 for location based communication according to some embodiments of the present disclosure. For illustrative purposes, the process 300 will be described with reference to FIGS. 1A to 1E and FIGS. 2A to 2D. Only as an example and without limitation, as shown in FIG. 3, the terminal device 110 may be the UE 110, ED 110 as shown in FIGS. 1A and 1B or the terminal devices as shown in FIGS. 2A to 2D, the NTN device 172 may be the NT-TRP 172 as shown in FIGS. 1B and 1C, or satellites as shown in FIGS. 2A to 2D.

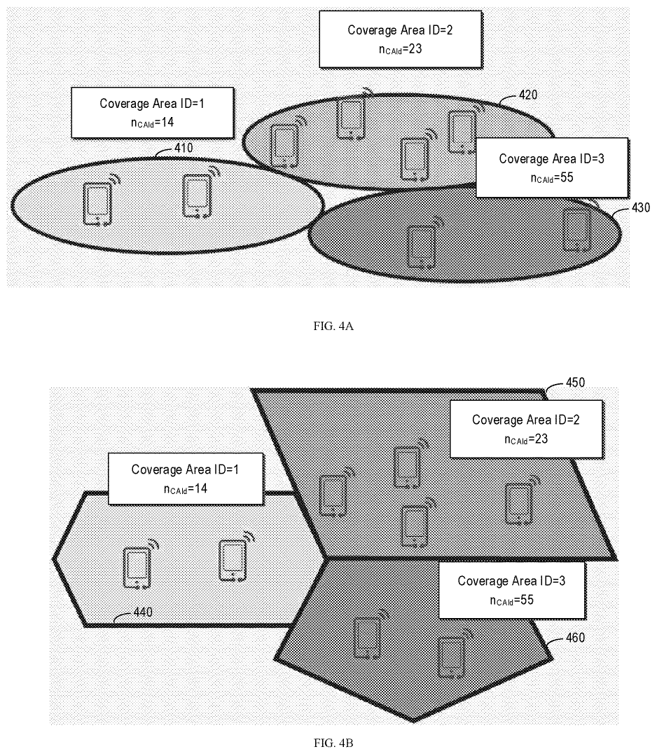

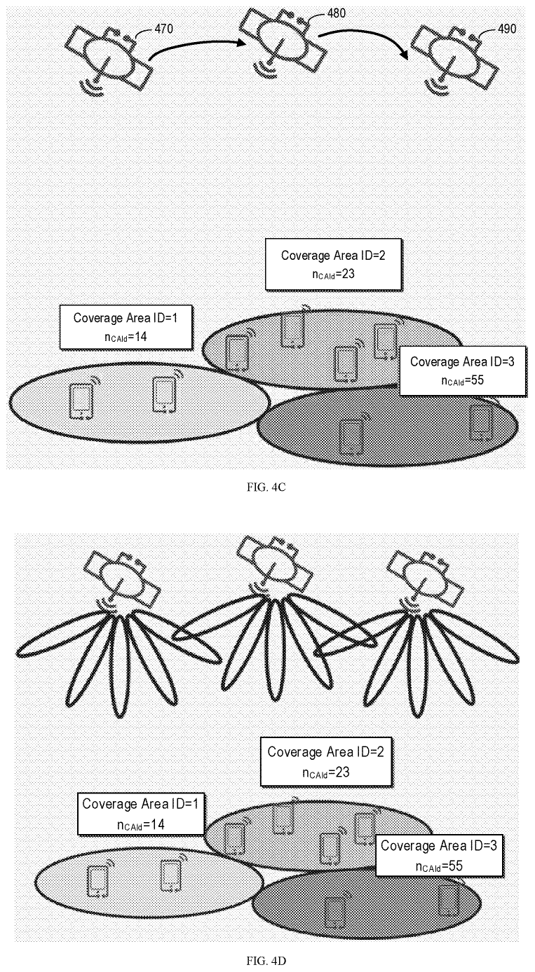

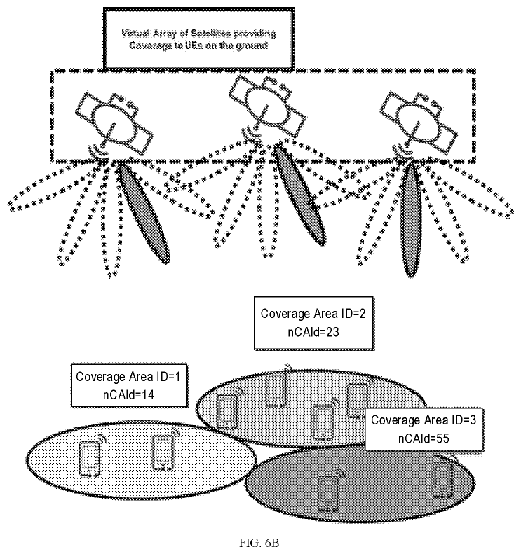

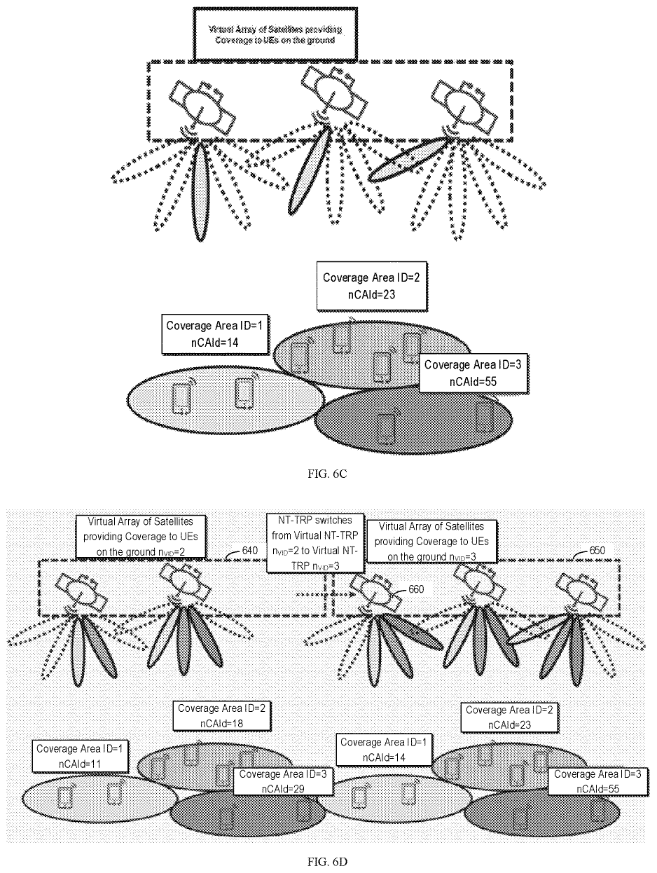

In the signaling process 300, the terminal device 110 obtains (310) identity information specific to a geographic area among a plurality of geographic areas covered by a non-terrestrial network (NTN). That is, the identity information is configured for a fixed geographic area on Earth, rather than the current actual coverage area of a moving NTN device in NTN. In some example embodiments of the disclosure, the identity information may include geographic area IDs, location-specific scrambling identity values corresponding the geographic area IDs. In addition or alternatively, the identity information may include a plurality of beam set identities, and a plurality of beam identities associated with a beam set identity of the plurality of beam set identities. These beams may be the transmit beam of NTN device. In addition or alternatively, the identity information may include one or more virtual identities of one or more virtual NTN devices, and a virtual NTN device of the one or more virtual NTN devices is formed by a set of NTN devices in the NTN. For discussion clarity, the identity information including the geographic area IDs, location-specific scrambling identity values corresponding the geographic area IDs and related concepts will be further discussed with reference to FIGS. 4A to 4D. The identity information including a plurality of beam set identities and a plurality of beam identities associated with a beam set identity of the plurality of beam set identities, and related concepts will be further discussed with reference to FIGS. 6A to 6C. The identity information including one or more virtual identities of one or more virtual NTN devices and related concepts will be further discussed with reference to FIGS. 7A to 7B. In the example embodiments of disclosure, the identity information may be used to scramble or initiate reference signal(s) transmitted towards the respective geographic area, so that the terminal device may receive, detect, measure or detect the reference signal(s) using the corresponding identity information. As such, the NTN may be enabled to be “transparent design” from the perspective of the terminal device, as mentioned above.

In some embodiments, the identity information may be preconfigured, or may be obtained from the NTN device 172. In some embodiments, the terminal device 110 may obtain (301) an elementary file from the Subscriber Identity Module (USIM) of the terminal device 110. This elementary file may include the identity information. In this case, the terminal device 110 may obtain the identity information from the preconfigured elementary file for the terminal device 110. In an example, the identity information may go from the USIM to the terminal device's Non-Access Stratum (NAS), to the terminal device's Access Stratum (AS) and eventually reach the terminal device physical layer.

In addition or alternatively, the NTN device 172 may also transmit (303) the identity information 305 to the terminal device 110. For example, even if the identity information is preconfigured, the identity information may be further adjusted/updated on demand. Then, the NTN may inform the updated/adjusted identity information to the terminal devices. The terminal device 110 may receive (307) the identity information 305 accordingly. Before transmitting (303) the identity information 305, the NTN device 170 has obtained (302) the identity information 305 specific to the geographic area among the plurality of geographic areas covered by the NTN in advance. In some embodiments, the identity information may be preconfigured or coordinated in the NTN. For example, once a NTN device joins the NTN, the NTN may configure this NTN device with the identity information 305. Moreover, in some embodiments, the identity information 305 may be updated at the NTN on demand. Then, as mentioned above, the updated identity information may be indicated by the NTN device 172 to the terminal devices on the ground.

Then, as mentioned above, at NTN side, NTN device 172 in NTN may use the corresponding identity information to initiate or scramble the reference signals for a certain geographic area, for example, the reference signals in the current cell covering the certain geographic area or reference signals transmitted by a transmit beam covering the certain geographic area. Specifically, the NTN device 172, transmits (320), based on the identity information, reference signal(s) 325 for a geographic area among a plurality of geographic areas covered by the NTN. This identity information is specific to the geographic area. The example embodiments regarding how to initiate the reference signals using the identity information is further discussed in detail with reference to FIGS. 4A to 7B. In turn, the terminal device 110 is able to receive (330) the reference signal(s) 325 in accordance with the identity information. For discussion purposes, the identity information including geographic area IDs, location-specific scrambling identity values corresponding the geographic area IDs and the associated configurations are further discussed with reference to FIGS. 4A to 4D.

FIG. 4A illustrates an example correspondence between a geographic area (identity, ID) and a location-specific scrambling identity according to some embodiments of the present disclosure.

In some embodiments, the identity information may be comprised in geographic area information (which may be also referred to as “coverage area information”), and the geographic area information is a portion of the elementary file from USIM, as mentioned above. Moreover, the identity information may indicate a plurality of geographic area identities that identify the plurality of geographic areas and a plurality of location-specific scrambling identity values corresponding to the plurality of geographic area identities.

In some embodiments, the plurality of location-specific scrambling identity values may correspond/be mapped to the plurality of geographic area identities one by one. Alternatively, without any limitation, the plurality of location-specific scrambling identity values may correspond to the plurality of geographic area identities in any other correspondence manner, and this is not limited in this disclosure. The location-specific scrambling identity may be also referred to as “a coverage area specific scrambling identity” in some embodiments of this disclosure.

In some embodiments, for the reference signal(s) to be transmitted towards a geographic area, the NTN device 172 may scramble the reference signal(s) by using a location-specific scrambling identity value corresponding to the geographic area identity of this geographic area. In an example, the NTN device 172 may transmit non-zero power channel state information reference signals (NZP CSI-RS) using the scrambling identity assigned for this geographic area, and the PRN binary sequence for NZP CSI-RS may be initialized with the following equation:

$${c}_{init} = ( {2}^{10} ( {N}_{symb}^{slot} {n}_{s , f}^{μ} + l + 1 ) ( 2 {n}_{CAId} + 1 ) + {n}_{CAId} ) mod {2}^{31} \qquad ( 1 )$$

where

$${N}_{symb}^{slot}$$

designates the number of OFDM symbols per slot,

$${n}_{s , f}^{μ}$$

designates the slot number within a given radio frame, l designates the OFDM symbol number within a slot and n_{cAId} designates the location-specific scrambling identity.

As shown in FIG. 4A, three geographic areas are defined on the ground, and each geographic area has a corresponding geographic area identity and one location-specific scrambling identity denoted as n_{cAId}. Specifically, for the geographic area 410, the geographic area ID (which may be also referred to as the coverage area ID) is “1”, and the corresponding location-specific scrambling identity value n_{cAId} is “14”. In some embodiments of this disclosure, the term “geographic area” may be also referred to as “coverage area”, and similarly, this coverage area may be a fixed area on Earth surface. In addition, for the geographic 420, the geographic area ID is “2”, and the corresponding location-specific scrambling identity value n_{cAId} is “23”. For the geographic 430, the geographic area ID is “3”, and the corresponding location-specific scrambling identity value n_{cAId} is “55”. The following Table 1 illustrates the correspondence between the geographic area ID and the location-specific scrambling identity value.

TABLE 1

| | |
|---|---|
| Coverage Area Identity | 1 [4 bits] |
| Coverage Area Scrambling Identity | 14 [10 bits] |
| Coverage Area Identity | 2 [4 bits] |
| Coverage Area Scrambling Identity | 23 [10 bits] |
| Coverage Area Identity | 3 [4 bits] |
| Coverage Area Scrambling Identity | 55 [10 bits] |

In some embodiments, if the reference signal is transmitted for the geographic area 410 (or coverage area 410) whose identity is equal to 1, then the location-specific scrambling identity (which may be also referred to as “coverage area specific scrambling identity”) whose value is equal to 14 may be used by the NTN device 172 to scramble or initiate the reference signal. If the reference signal is transmitted for the geographic area 420 (or coverage area 420) whose identity is equal to 2, then the location-specific scrambling identity whose value is equal to 23 may be used by the NTN device 172 to scramble or initiate the reference signal. If the reference signal is transmitted for the geographic area 430 (or the coverage area 430) whose identity is equal to 3, then the location-specific scrambling identity whose value is equal to 55 may be used by the NTN device 172 to scramble or initiate the reference signal.

In some embodiments, assuming that the terminal device 110 is able to receive, detect and measure Global Navigation Satellite System (GNSS) signals and use those signals to acquire their own position. Then, the terminal device 110 may use the identity information specific to these coverage areas in order to attempt to receive, detect and measure physical layer reference signals, such as synchronization signals or NZP CSI-RS. In some embodiments, the terminal device 110 may determine a target geographic area identity from the plurality of geographic area identities. This target geographic area identity identifies a target geographic area in which the terminal device 110 is located. Then, the terminal device 110 may receive (330) the reference signal 325 using a location-specific scrambling identity value of the plurality of location-specific scrambling identity values which corresponds to the target geographic area identity. As an example, if the terminal device 110 is in the geographic area 410 whose identity is “1”, then the terminal device 110 may attempt to receive, detect and measure reference signals using the location-specific scrambling identity value of “14”. If the terminal device 110 is in the geographic area 420 whose identity is “2”, then the terminal device 110 may attempt to receive, detect and measure reference signals using the location-specific scrambling identity value of “23”. If the terminal device 110 is in the geographic area 430 whose identity is “3”, then the terminal device 110 may attempt to receive, detect and measure reference signals using the location-specific scrambling identity value of “55”. Thus, the reception, decoding or measurement operations at the terminal device 110 located in a geographic area may be “matched” with reference signals transmitted for the geographic area. Then, from the perspective of the terminal devices located in the geographic area, the NTN enables “transparent design” as mentioned above.

In addition, in some embodiments, the elementary file in USIM may further include a field indicating a shape type of the geographic area, locations of vertexes of the geographic area, or any combination of them. As an example, the elementary file containing the identity information may further include information regarding the coordinates of the coverage area. In addition, the coverage area may be described as a polygon with at least three points. Each point is provided with a corresponding latitude and longitude values, such that each point can be uniquely identified on Earth. An example of the content of the coverage areas expanded with coverage area polygon may represented in Table 2 and FIG. 4B.

TABLE 2

| | |
|---|---|
| Coverage Area Identity | 1 [4 bits] |
| Coverage Area Scrambling Identity | 14 [10 bits] |
| Coverage Area Polygon - Polygon type | 6 [4 bits] |
| Coverage Area Polygon - Latitude of Point 1 | [24 bits] |
| Coverage Area Polygon - Longitude of Point 1 | [24 bits] |
| Coverage Area Polygon - Latitude of Point 2 | [24 bits] |
| Coverage Area Polygon - Longitude of Point 2 | [24 bits] |
| Coverage Area Polygon - Latitude of Point 3 | [24 bits] |
| Coverage Area Polygon - Longitude of Point 3 | [24 bits] |
| Coverage Area Polygon - Latitude of Point 4 | [24 bits] |
| Coverage Area Polygon - Longitude of Point 4 | [24 bits] |
| Coverage Area Polygon - Latitude of Point 5 | [24 bits] |
| Coverage Area Polygon - Longitude of Point 5 | [24 bits] |
| Coverage Area Polygon - Latitude of Point 6 | [24 bits] |
| Coverage Area Polygon - Longitude of Point 6 | [24 bits] |
| Coverage Area Identity | 2 [4 bits] |
| Coverage Area Scrambling Identity | 23 [10 bits] |
| Coverage Area Polygon - Polygon type | 4 [4 bits] |
| Coverage Area Polygon - Latitude of Point 1 | [24 bits] |
| Coverage Area Polygon - Longitude of Point 1 | [24 bits] |
| Coverage Area Polygon - Latitude of Point 2 | [24 bits] |
| Coverage Area Polygon - Longitude of Point 2 | [24 bits] |
| Coverage Area Polygon - Latitude of Point 3 | [24 bits] |
| Coverage Area Polygon - Longitude of Point 3 | [24 bits] |
| Coverage Area Polygon - Latitude of Point 4 | [24 bits] |
| Coverage Area Polygon - Longitude of Point 4 | [24 bits] |
| Coverage Area Identity | 3 [4 bits] |
| Coverage Area Scrambling Identity | 55 [10 bits] |
| Coverage Area Polygon - Polygon type | 5 [4 bits] |
| Coverage Area Polygon - Latitude of Point 1 | [24 bits] |
| Coverage Area Polygon - Longitude of Point 1 | [24 bits] |
| Coverage Area Polygon - Latitude of Point 2 | [24 bits] |
| Coverage Area Polygon - Longitude of Point 2 | [24 bits] |
| Coverage Area Polygon - Latitude of Point 3 | [24 bits] |
| Coverage Area Polygon - Longitude of Point 3 | [24 bits] |
| Coverage Area Polygon - Latitude of Point 4 | [24 bits] |
| Coverage Area Polygon - Longitude of Point 4 | [24 bits] |
| Coverage Area Polygon - Latitude of Point 5 | [24 bits] |
| Coverage Area Polygon - Longitude of Point 5 | [24 bits] |

FIG. 4B illustrates examples of shape types of the geographic area according to some embodiments of the present disclosure.

As shown in FIG. 4B and listed in Table 2, for the geographic area 440 having the geographic area identity “1” (or Coverage Area Identity=1), the elementary file may indicate/describe the geographic area as a polygon with six points, i.e. a hexagon. In some embodiments, there may be a shape type field (which may be also referred to as a polygon type) to indicate to the terminal device 110 what the type of the polygon is, and this may help the terminal device 110 to realize about the number of points whose latitude and longitude is provided for the corresponding coverage area. For the geographic area having the Coverage Area Identity “1”, the polygon type field has a value of 6, i.e. six points will be supplied. Each point may be provided with a latitude and longitude, where the latitude and longitude may be coded over e.g. 24 bits.

For the geographic area 450 having the geographic area identity “2” (or Coverage Area Identity=2), the elementary file may indicate/describe it as a polygon with four points, i.e. a quadrilateral. In this case, the shape type field may be a value representing “quadrilateral”. Then, the terminal device 110 may be aware of the number of points whose latitude and longitude is provided for the corresponding coverage area. For the geographic area having the Coverage Area Identity “2”, the polygon type field has a value of 4, i.e. four points will be supplied. Each point may be provided with a latitude and longitude, where the latitude and longitude may be coded over e.g. 24 bits.

For the geographic area 460 having the geographic area identity “3” (or Coverage Area Identity=3), the elementary file may indicate/describe it as a polygon with five points, i.e. a pentagon. In this case, the shape type field may be a value representing “pentagon”. Then, the terminal device 110 may be aware of the number of points whose latitude and longitude is provided for the corresponding coverage area. For the geographic area having the Coverage Area Identity “3”, the polygon type field has a value of 5, i.e. five points will be supplied. Each point may be provided with a latitude and longitude, where the latitude and longitude may be coded over e.g. 24 bits. It is to be understood that the geographic areas may be of any type of shape, and the above embodiments are only an example of a combination showing three different types of polygons.

As mentioned above, the terminal device 110 may acquire its position by GNSS signals, and the terminal device 110 can determine which coverage area in which the terminal device 110 located in. With the determined coverage area, the terminal device 110 may then use the corresponding location-specific scrambling identity in order to receive, detect and measure the corresponding reference signal(s).

In some embodiments, in addition to the identity information, the geographic information may further indicate a number of slots within a radio frame, a slot in which the reference signal is transmitted, a number of symbols within a slot, or an index for a symbol. As an example, the geographic area information may include a value indicating the number of slots within the radio frame, which is denoted by

$${n}_{s , f}^{μ} .$$

In addition or alternatively, the geographic information may indicate the slot in which the reference signal may be transmitted. Furthermore, the coverage area information may also include a value for the number of OFDM symbols per slot, which is denoted by,

$${N}_{symb}^{slot} .$$

The coverage ara information may also include a value for the index of the OFDM symbol within the slot, which is denoted by the letter “l”.

In addition, in some embodiments, the (preconfigured) elementary file may include timing reference information. For example, in addition to the geographic area information containing the identity information, the elementary file may include timing reference information indicating reference time, a system frame number, a radio frame number, a slot number, a symbol number, or any combination of them. The terminal device 110 may have an internal clock system that provides the terminal device 110 with the absolute time within a given error margin in for example a nano-second level. The timing reference information included in the elementary file may be used by the terminal device 110, for example when the terminal device 110 is not connected with the network. Specifically, the timing reference information may provide the terminal device 110 with information about the frame structure, the boundaries of the radio frame, the boundaries of the slots within the radio frame, the boundaries of the OFDM symbols within the slots, etc. The following Table 3 shows an example of the timing reference information.

TABLE 3

| | |
|---|---|
| Reference Time | [32 bits] |
| System Frame Number | [10 bits] |
| Radio Frame Number | [10 bits] |
| Slot Number | [4 bits] |
| Symbol Number | [4 bits] |

As listed in Table 3, the “Reference Time” field in the timing reference information may indicate an absolute time within a given day, e.g. 10:00:00. As an example, the reference time may be given as an integer number of seconds from midnight (i.e. any integer number between 0 and 86399). Other units of time may be contemplated for “Reference Time” e.g. milli-seconds, micro-seconds, nano-seconds, and so on. In some other embodiments, the reference time may be also given as the number of hours, minutes and/or seconds from a given time of a day, without any limitation. The “System Frame Number” field in the timing reference information may indicate the system frame number of the frame which is transmitted starting at the time provided by “Reference Time”. The “Radio Frame Number” field in the timing reference information may indicate the radio frame number of the frame which is transmitted starting at the time provided by “Reference Time” within the system frame indicated by “System Frame Number”. In addition, the “Slot Number” field in the timing reference information may indicate the number of the slot which is transmitted starting at the time provided by “Reference Time” within the radio frame indicated by “Radio Frame Number”. The “Symbol Number” field in the timing reference information may indicate the OFDM symbol number of the symbol which is transmitted starting at the time provided by “Reference Time” within the slot indicated by “Slot Number”.

In addition, in some embodiments, the terminal device 110 may be provided with a “Reference Time Periodicity” field which may indicate the periodicity of the “Reference Time” field. As an example, assuming that the “Reference Time” field indicates a time of 10:00:00 and the “Reference Time Periodicity” field indicates a periodicity of 1 hour. Then, the terminal device 110 may be aware that the System Frame having the given “System Frame Number” that was transmitted at 10:00:00 may be transmitted again at 11:00:00, then again at 12:00:00, then again at 13:00:00, and so on. In this way, the terminal device 110 is allowed to find reference signals transmitted by NTN (for example, NT-TRP) in the time domain. This facilitate the terminal device 110 find e.g. synchronization signals and/or beams transmitted by NT-TRPs more quickly and with lower complexity.

In addition, with the identity information or geographic area information having the identity information, the terminal devices are not required to perform the handover between physical cells provided by NTN frequently. In other words, the network transparency is enabled.

FIG. 4C illustrates an example NTN device “transparency” from the perspective of the terminal devices in the case of location based communication according to some embodiments of the present disclosure.

As shown in FIG. 4C, the NTN device 172 (for example, the satellite in FIG. 4C) may move from the first orbit location 470 to the third orbit location 490 passing the second orbit location 480. It is to be understood that the number of NTN devices in FIG. 4C is only for illustration purposes, there may be a plurality of other NTN devices in NTN which is not shown. With the movement of the NTN device 172, the actual area covered by the NTN device 172 may be changed accordingly. For example, when the NTN device 172 moves from the first orbit location 470 to the second orbit location 480, the actual area covered by the NTN device 172 may change from the geographic area with the geographic area ID=1 to another geographic area with the geographic area ID=2. In this case, in some embodiments, the current NTN device (for example, another NTN device following the NTN device 172) providing service for the geographic area with the geographic area ID=1 use the location-specific scrambling identity value “14” to transmit the reference signal(s) for the geographic area with the geographic area ID=1. In turn, the NTN device 172 may use the location-specific scrambling identity value “23” to transmit the reference signal(s) for the geographic area with the geographic area ID=2. As such, the terminal devices in these geographic areas may receive, measure or detect the reference signals(s) for the respective geographic area only based on the location information, without considering the movement of the NTN devices.

That is, the terminal devices are looking for reference signals whose PRN binary sequence is generated based on the scrambling identity associated with the coverage area in which terminal devices are located in. Thus, the terminal devices don't need to be signaled any information regarding the type of network node that is transmitting these signals, e.g. whether the network node is a terrestrial TRP such as a base station, or a non-terrestrial TRP such as a satellite, a balloon, a high altitude platform station, a drone, etc., this is how network transparency may be achieved. As an example, the reference signals may be transmitted by non-terrestrial TRPs such as satellites.

Moreover, in this case, the plurality of NTN devices in NTN may be like a “one network node” from the perspective of the terminal devices. FIG. 4D illustrates another example NTN device “transparency” from the perspective of the terminal devices in the case of location based communication according to some embodiments of the present disclosure. In the FIG. 4D, the geographic area identity (i.e., coverage area ID) and location-specific scrambling identity value (i.e., n_{cAId}) may be similar as that in FIG. 4C.

As shown in FIG. 4D, although NTN may include a large amount of NTN devices, the NTN devices may be coordinated together such that they appear as just one network node as far as devices on the ground are concerned.

In FIG. 4D, three satellites are shown, any of the three satellites could be coordinated to transmit beams such that it covers the respective geographic area(s). As mentioned above, by dissociating the scrambling identity from the NT-TRP and associating the scrambling identity with a given coverage area, the terminal devices within the given coverage area are allow to benefit from an improver user experience because these devices would not experience a “change” in the scrambling identities used to receive, detect and measure reference signals, which in turn would not trigger mobility-related procedures.

In some embodiments, the steps discussed in the above embodiments may be used when the terminal device 110 is not connected to the network (e.g. in idle mode). For example, the terminal device 110 in idle mode may use the geographic information provided in their USIM to attempt to receive, detect and measure reference signals for Initial Access, e.g. Synchronization Signals or NZP CSI-RS. This allows the terminal device 110 to acquire DL synchronization in the time domain. The geographic information may be retrieved from the USIM and then provided by the terminal device's higher layers to the terminal device's lower layers and physical layer. Then, when the terminal device's starts to search for reference signals, the terminal device may assume that the reference signal's binary sequence is generated based on a Gold sequence and initialized based on the coverage area's scrambling identity. In some other embodiments, without any limitation, the steps discussed in the above embodiments may be also used when the terminal device is in a connected mode.

In this way, the concept of geographic area (or coverage area) is introduced, and in particular the concept of the location-specific scrambling identity values for reference signals is introduced. In some embodiments, the geographic area (or coverage area) may be defined as areas where the terminal devices may expect to receive, detect and measure reference signals whose PRN binary sequences may be initialized with a scrambling identity that is a location-specific. The PRN binary sequence may be e.g. a maximal-length sequence, a Gold sequence, a Kasami sequence, a Barker sequence, etc.

As such, location-specific scrambling identities may be provided to devices such as e.g. UEs as part of geographic area information (or coverage area information). Coverage Area information may be provided to UEs from the UE's Subscriber Identity Module (USIM), where so-called elementary files may include information about relevant coverage areas which correspond to where the UE may be located. The information may go from the USIM to the UE's Non-Access Stratum (NAS) to the UE's Access Stratum (AS) and eventually reach the UE's physical layer, where the UE can start applying the location-specific scrambling identity or identities for the reception, detection and measurement of reference signals transmitted by e.g. non-terrestrial TRPs. There may be several benefits from defining Coverage Areas and location-specific scrambling identities. The first benefit would be in terms of network transparency and the second benefit would be in terms of reducing signaling overhead (especially in terms of mobility). The location-specific scrambling identity or identities are used by all the non-terrestrial TRPs (e.g. satellites). Therefore, UEs on the ground located within the corresponding coverage area would attempt to receive, detect and measure reference signals whose PRN binary sequences are initialized with the location specific scrambling identity or identities. Different non-terrestrial TRPs may come and go as they travel along their orbit, however devices on the ground wouldn't notice any differences or changes, and thus may not trigger any mobility or handover procedures at the UEs on the ground.

Referring back to FIG. 3, in some embodiments, the terminal device 110 cannot determine its location, for example, the terminal device 110 is not configured with GNSS capability. In this case, the “transparency design” is difficult to implement only by the configured geographic area information (for example, the geographic area ID and corresponding location-specific scrambling identity value).

Only for discussion purposes, in an example, assuming that the terminal device 110 is not connected to the network and thus in idle mode or equivalently in a power saving mode that is associated with idle mode. In some cases, the terminal device 110 may attempt to initiate an Initial Access in order to connect with e.g. NTN where the non-terrestrial TRPs (NT-TRPs) are e.g. satellites. However, the terminal device 110 does not have Positioning capabilities, i.e. these terminal devices are not capable of receiving, detecting and measuring Global Navigation Satellite System (GNSS) signals and use those signals to acquire their position. As a result, the terminal device 110 may cannot compare its position with that of coverage areas, i.e. it cannot determine that it is within a given coverage area. As mentioned above, in this case, the “transparency design” is difficult to implement by preconfigured geographic area information.

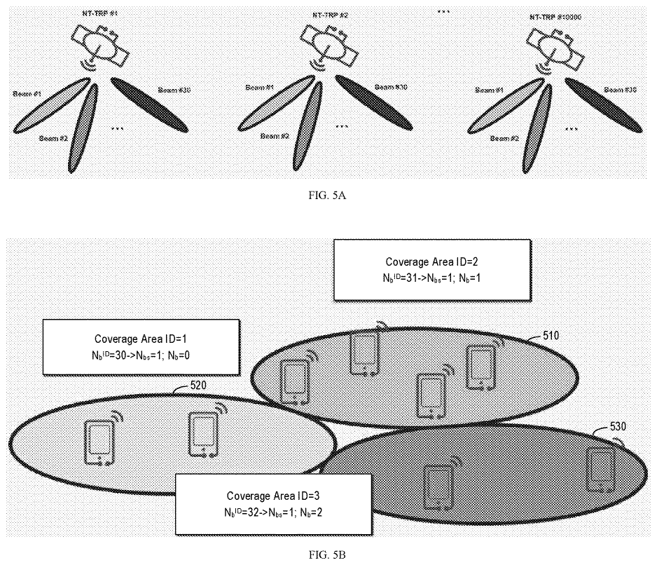

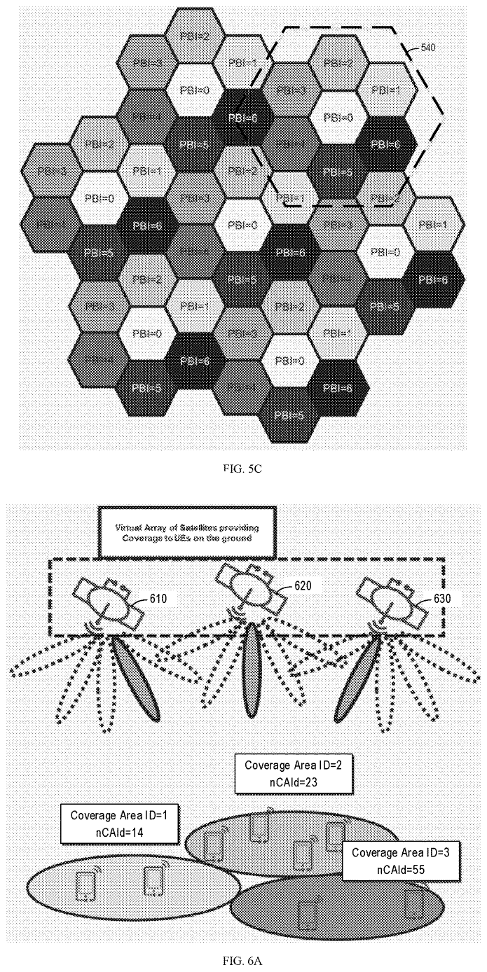

Then, assuming that the terminal device 110 selects a frequency band that is associated with operation in non-terrestrial networks, the terminal device 110 also need to know how to select/receive a transmit beam of NTN. However, the NTN devices, such as satellites, may transmit several tens of beams towards the ground, and there may be so-called mega constellations comprising in the order of ten thousand NT-TRPs. Thus, this may result in a communication system comprising in the order of hundreds of thousands of beams and possibly in the order of one million beams. FIG. 5A illustrates an example of massive beams transmitted from NTN devices in NTN according to some embodiments of the present disclosure. As shown in FIG. 5A, a mega constellation may comprise up to, for example, 10000 NTN devices (e.g. satellites). As shown, the 10000 NTN devices can be referred to as NT-TRP #1 to NT-TRP #10000 and each NTN device may transmit up to, for example, 30 beams, referred to as Beam #1 to Beam #30. It is to be understood that the above number are only used for discussion purposes, the device number and/or beam number in NTN is not limited in this disclosure.

As a result, performing the Initial Access in a communication system comprising a number of beams in the order of hundred thousand to a million may be prohibitively complex for the terminal device to search through and select a beam.

As mentioned above, alternatively to the geographic area identity and the corresponding location-specific scrambling identity values, the identity information may include a plurality of beam set identities, and a plurality of beam identities associated with a beam set identity of the plurality of beam set identities. In some embodiments, to reduce the complexity at the terminal device, the concepts of physical beam identity, beam set identity and beam identity are introduced in the example embodiments of this disclosure. The physical beam identity can be used to identify a transmit beam at the physical layer. The beam set identity may be used to indicate a set of transmit beams of NTN device(s), and an associated beam identity may be used to indicate a beam from the set of transmit beams. The physical beam identity may be determined based on the beam set identity and the associated beam identity. As mentioned above, NTN may have a large amount of beams, and the terminal device is required to receive a transmit beam by searching all of the transmit beams if only using the unique identity of the transmit beam of NTN device(s). Thus, the complexity at the terminal device is increased. In some embodiments of this disclosure, the beam set identity, the beam identity and even the physical identity can be reused, in order to reduce the complexity.

In some embodiments, the transmit beams of a plurality of NTN devices may be divided into a plurality of beam sets each of which may be identified by a respective beam set identity. Moreover, in some embodiments, a beam set of the plurality of beam sets may be specific to a geographic area among the plurality of geographic areas covered by NTN. In addition, a beam may be uniquely identified from the associated beam set by a corresponding beam identity. Furthermore, a different beam from another beam set may have this same beam identity. That is, in some embodiments, a beam identity may be unique with respect to a geographic area associated with a beam set including the beam having this beam identity. Moreover, the same beam identity may be reused in different beam sets for more than one time. In addition or alternatively, in some embodiments, different beam set identities may be also used or re-used by different NTN devices to achieve global coverage in the way that doesn't generate a lot of inter-beam interference. For example, the same beam set identity and/or beam identity may be specific to different geographic areas which are far apart from each other.

In this way, a beam (or a physical beam identity) can be identified by a “two-level” structure, i.e., the beam set identity->a respective beam identity associated with the beam set identity. In some embodiments, the beam set identity and the beam identity may be combined with the primary synchronization signal (PSS) and secondary synchronization signal (SSS). For example, the PSS transmitted via a first transmit beam may be determined based on a first beam set identity which identifies a beam set including the first transmit beam, and the SSS transmitted via the first transmit beam may be determined based on a first beam identity. In this case, beams may be found by searching for and detecting PSS and SSS. As such, since the beam set identity, beam identity and even the physical beam identity can be reused, i.e., the total number of identities is reduced, and thus the complexity for receiving a transmit beam from NTN may be reduced.

That is, to allow the terminal device 110 to perform Initial Access in NTN such as a mega constellation without going through prohibitively high complexity Initial Access, different levels of synchronization signal identities are defined. The first level of synchronization may be defined to allow the terminal device 110 to search for “beam sets”. In an example, beam sets may be defined, such as, there may be a positive integer number N (for example, N=20) of beam sets. In some embodiments, the terminal device 110 may receive, detect and measure (330) PSS 325 which are generated based on a given beam set identity.

As an example, PSS may use a binary sequence of length 256 bits. The PRN binary sequence for PSS may be generated based on, for example, a maximal length sequence or m-sequence as follows:

$${d}_{PSS} ( n ) = 1 - 2 x ( m ) \qquad ( 2 )$$

$$m = ( n + {AN}_{bs} ) mod 255$$

$$0 \leq n < 255$$

$$x ( i + 7 ) = ( x ( i + 4 ) + x ( i ) ) mod 2$$

$$[ x ( 6 ) x ( 5 ) x ( 4 ) x ( 3 ) x ( 2 ) x ( 1 ) x ( 0 ) ] = [ \begin{matrix}1 & 0 & 0 & 0 & 1 & 0 & 0\end{matrix} ]$$

where d_{PSS} denotes the binary sequence of length 256 used by the PSS; m and n are both integer values between 0 and 255; A is an integer value higher than 0; and N_{bs} denotes the beam set identity which is an integer number between, for example, 1 and 20.

In some embodiments, after receiving, detecting and measuring a PSS within a beam set, the second level of synchronization may be defined to allow the terminal device 110 to search for beam(s) within the corresponding beam set. For example, the terminal device 110 may receive, detect and measure (330) SSS 325 which are generated based on a given beam set identity. In some embodiments, assuming that the SSS may use binary sequence of length 256 bits, and each beam set may contain up to

$${N}_{b}^{bs} = 30$$

beam identities. The PRN binary sequence for SSS may be generated based on, for example, a maximal length sequence or m-sequence as follows:

$${d}_{SSS} ( n ) = 1 - 2 x ( m ) \qquad ( 3 )$$

$$m = ( n + {BN}_{b} ) mod 255$$

$$0 \leq n < 255$$

$$x ( i + 7 ) = ( x ( i + 4 ) + x ( i ) ) mod 2$$

$$[ x ( 6 ) x ( 5 ) x ( 4 ) x ( 3 ) x ( 2 ) x ( 1 ) x ( 0 ) ] = [ \begin{matrix}0 & 1 & 1 & 0 & 1 & 0 & 0\end{matrix} ]$$

where d_{SSS} denotes the binary sequence of length 256 used by the SSS; m and n are both integer values between 0 and 255; B is an integer value higher than 0; and N_{b} denotes the beam identity which is an integer number between, for example, 1 and 30. In some embodiments, different beam identities may be used or re-used by different NTN devices to achieve global coverage in a way that doesn't generate a lot of inter-beam interference.

As mentioned above, the physical beam identity may be determined based on a beam set identity and a beam identity. In an example, the physical beam identity may be derived by the following:

$${N}_{b}^{ID} = {N}_{b}^{bs} {N}_{bs} + {N}_{b} \qquad ( 4 )$$

where

$${N}_{b}^{ID}$$

denotes the physical beam identity,

$${N}_{b}^{bs}$$

denotes the number of beam identities per beam set, N_{bs} denotes the beam set identity and N_{b} denotes the beam identity. In this example, if the beam set identity is not reused, then the physical beam identity will not be reused even if the beam identities are reused. In turn, in this example, if the beam set identity is enabled to be reused, the physical beam identity will be reused accordingly.

Since different synchronization reference signals, such as PSS and SSS, may be transmitted using different beams (or equivalently different spatial filters), upon successfully receiving, detecting and measuring given synchronization reference signals (such as, PSS and SSS), the terminal device 110 may effectively detect the beam providing coverage for a given geographic area.

FIG. 5B illustrates an example correspondence between a beam set identity, a beam identity of a beam in the beam set and a geographic area as well as a physical identity of the beam that can be determined based on the beam set identity and the beam identity according to some embodiments of the present disclosure. In FIG. 5B, the N_{b}^{ID} denotes the physical beam identity, the N_{bs} denotes the beam set identity, and the N_{b} denotes the beam identity.

As an example, different physical beam identities may correspond to different geographic areas, as shown in FIG. 5B. Taking the geographic area having the geographic area identity (which may be also referred to the coverage area ID) “1” as an example, assuming that this geographic area is associated with (or covered by) the physical beam identity

$$( i . e . {N}_{b}^{ID} )$$

equal to 30. In this case, within this coverage area, the PSS binary sequence is generated using the beam set identity (i.e. N_{bs}) equal to 1, and the SSS binary sequence is generated using the beam identity (i.e. N_{b}) equal to 0.

Then, at the terminal device 110 side, in the case that the terminal device 110 has no prior knowledge of any association between the geographic area and the physical beam identity, the terminal device 110 has to blindly receive, detect and measure the PSS and SSS by assuming physical beam identity values. With the above identity information, the complexity of blind reception, detection and measurement can be reduced. Assuming that the terminal device is located within the coverage area whose coverage area identity is equal to 1. The terminal device may use the relative small number of beam set identities and beam identities to receive, detect and measure the PSS and the SSS, compared to directly using a further beam identity identifying a beam uniquely. Once the PSS and SSS are successfully received, detected and measured (for example, the terminal device 110 uses N_{bs}=1 to receive PSS and uses N_{b}=0 to receive SSS), the terminal device may determine the physical beam identity accordingly. In turn, the terminal device 110 may perform Initial Access and establish a connection with the NTN based on the physical beam identity.

FIG. 5C illustrates examples of beam sets of which each has a plurality of respective beams and corresponding covered geographic areas according to some embodiments of the present disclosure.

In the embodiment as shown in FIG. 5C, the beam set identity is completely reused (for example, the beam set identity is equal to 0 for each beam set). Taking the beam set 540 covering a geographic area on Earth as an example, a beam identity may uniquely identify a respective beam from this beam set 540. In this way, the terminal device 110 located in this geographic area may use the beam set identity “o” to receive PSS and use a beam identity to receive a SSS, in order to select a transmit beam from the seven beams in the beam set. In this case, the physical beam identities may be also reused in different beam sets.

In view of the above, using such “physical beam identities (PBIs)” allows the terminal device to perform Initial Access with a reduced level of complexity, even if the terminal devices cannot determine its location. In order to establish a communication link (e.g. an RRC connection) with the NTN such as a satellite constellation, the terminal device 110 has to search for beams however one of the prominent issues in non-terrestrial systems is that NTN devices such as Low Earth Orbit (LEO) satellites are always in movement. This causes beams to “come and go” because satellites transmitting those beams “come and go”. By dissociating physical beam identities from the NTN devices, the problem of triggering mobility procedures upon the beam going away can be avoided, because different NTN devices (e.g. on the same orbit) may transmit beams using the same physical beam identity (for example, when a beam is to cover the geographic area to which this physical beam identity is specific). This allows the terminal devices to continue the same physical beam identity and thus maintain its RRC connection. A change in the physical beam identity may trigger mobility procedures, which would cause interruption and latency in the device's user experience. In some embodiments of this disclosure, different coverage areas may use the same physical beam identity value such that inter-beam interference is low enough and the signal to interference and noise ratio is high enough for communication to be possible with devices on the ground. Such reuse of physical beam identities may be that the “Beam Search” procedure would have lower complexity for devices on the ground as it reduces the number of physical beam identities that the devices would be attempting to detect.

In addition, in some embodiments, to reduce the inter-beam interference, the beam hopping may be enabled. As an example, activated transmit beams of NTN are hopped between the plurality of beam subsets, in order to mitigate the inter-beam interference. In addition, a beam subset of the plurality of beam subsets may be associated with a geographic area identity identifying a geographic area, and the beam subset may be associated with a physical identity of a beam. In this way, all of transmit beams from NTN device(s) may not be transmitted all at the same time, as it may lead to severe inter-beam interference problems. In some embodiments, the NTN device 172 may transmit a sub-set of beams at a given time and in the same time/frequency resources, and the sub-set of beams may be chosen such that inter-beam interference is limited. Depending on the time-slot, different sub-sets of beams may be transmitted by the NTN device 172, all with respect to the constraint of mitigating inter-beam interference, this may constitute the “hopping” from one sub-set of beams to another sub-set of beams. In addition, in some embodiments, the given sub-set of beams may be further associated with one or more location-based scrambling identities, as mentioned above. Similarly, the given sub-set of beams may be associated with one or more physical beam identities. This kind of association may link together a sub-set of beams (or equivalently spatial filters) with one or more scrambling identities used to generate the corresponding one or more PRN binary sequences, and each of the one or more PRN binary sequences corresponding to a reference signal e.g. a NZP CSI-RS, a synchronization signal, demodulation reference signal.

Referring back to FIG. 3, in addition to the geographic area information or the beam identity-related information or alternatively, the NTN devices in NTN may be coordinated or organized to control/steer transmit beams of these NTN devices, in order to provide a cell coverage for a given geographic area in the manner in which the served terminal device located in the given geographic area cannot detect that the beam/cell is switched. The concept “virtual NTN device” may be introduced to reduce the terminal devices' complexity. In some embodiments, the identity information may include one or more virtual identities of one or more virtual NTN devices, and a virtual NTN device of the one or more virtual NTN devices is formed by a set of NTN devices in the NTN. The virtual identity may be also referred to as “virtual transmit identity” or “group transmit identity” in some embodiments of this disclosure.

NTN (which may be also referred to as NT-TRP system in some embodiments) such as satellite constellations may include in the order of tens of thousands of satellites, however the terminal devices on the ground may not be aware of the presence of all of those satellites in the constellation. Instead, the terminal devices may be aware of “virtual transmit identities” or “group transmit identities” which would be associated with a set of one or more NT-TRPs. Each set of one or more NT-TRPs (or NTN devices) may be referred to as a “virtual NTN”, “virtual NT TRP”, “enhanced NT-TRP” or “super NT-TRP”. For the sake of simplicity, in some embodiments of this disclosure, the term “virtual NTN (virtual NT TRP)” may refer to a set of one or more NTN devices (NT-TRPs) that are collaborating together to transmit beams, reference signals and physical layer channels towards devices on the ground. Each virtual NT-TRP may be able to transmit multiple beams depending on the transmission capabilities of the NT-TRPs that constitute the virtual NT-TRPs. To discuss clarity, the embodiments regarding the identity information including the virtual identities are further discussed with reference to FIGS. 6A to 6D.

FIGS. 6A to 6C illustrates an example of virtual NT-TRPs formed by one or more actual NT-TRPs and virtual identities of the virtual NT-TRPs that are used for reference signals in a corresponding geographic area according to some embodiments of the present disclosure.

As shown in FIG. 6A, assuming that three coverage areas (or geographic areas) are defined on the ground, and each coverage area has a corresponding coverage area identity and one location-specific scrambling identity denoted as n_{cAId}. In addition, beams in full line are shown as the beams providing coverage to a given coverage area, whereas beams in dashed line are shown as beams providing to coverage areas not shown in the figure. It should be understood that the terminal devices on the ground may also use the location-specific scrambling identity to receive, detect and measure the reference signal corresponding to this coverage area. Therefore, these terminal devices may not be aware that there are three NT-TRPs actually collaborating to form one virtual NT-TRP.

Assuming that there are three NTN devices, i.e., the NTN device 610, NTN device 620 and NTN device 630 in FIG. 6A, are grouped together and forming a “virtual NTN device” above the geographic areas. In some embodiments, this virtual NT-TRP may be considered as a distributed phased antenna array where each of the individual NT-TRPs collaborate in order to provide better beamforming capability towards the ground. In other words, an actual NTN device of the set of NTN devices forming a virtual NTN may act as an array element of a virtual array for the virtual NTN. “Better beamforming” may mean that the resulting beam from the virtual NT-TRP results in a narrower and more focused beam, the narrowness of a beam may be using e.g. the half power beam-width (HPBW), where the HPBW corresponds to the angular width where the major lobe of the beam experiences a power loss of half when compared to the point where the beam experiences its peak power (i.e. the direction where the signal strength would be the strongest). As shown in FIG. 6A, each NT-TRP (or NTN) within the virtual NT-TRP may transmit its beam towards the coverage area having the geographic area identity=2 (or coverage area ID=2). In this way, the “virtual array” of satellites may provide the coverage on terminal devices for the given area (i.e, coverage area ID=2) on the ground.

As shown in FIG. 6B, similarly, beams in full line are shown as the beams providing coverage to a given coverage area, whereas beams in dashed line are shown as beams that may be providing to coverage areas not shown in FIG. 6B. It should be understood that the terminal devices on the ground may use the location-specific scrambling identity to receive, detect and measure the reference signal corresponding to this coverage area, and therefore: these devices may not be aware that there are three NT-TRPs actually collaborating to form one virtual NT-TRP. In the embodiment as shown in FIG. 6B, this virtual NT-TRP may individually transmit another beam towards the coverage area having the geographic area identity=3 (or coverage area ID=3). As such, the “virtual array” of satellites may provide the coverage on terminal devices for the given area (i.e, coverage area ID=3) on the ground. As shown in FIG. 6C, similarly, beams in full line are shown as the beams providing coverage to a given coverage area, whereas beams in dashed line are shown as beams that may be providing to coverage areas not shown in FIG. 6C. For analogous reasons, the virtual NT-TRP may transmit another beam towards the geographic area identity=1 (or coverage area ID=1). As such, the “virtual array” of satellites may provide the coverage on terminal devices for the given area (i.e, coverage area ID=1) on the ground.

As discussed in the embodiments shown in FIGS. 6A to 6C, the NTN devices in NTN are organized/coordinated/collaborated together to control/steer the respective transmit beams of these NTN devices. These NTN devices may be considered as one virtual NTN. Moreover, the reference signals transmitted from these NTN devices to a given geographic area (for example, the geographic area having the coverage area ID=1, 2 or 3, as shown in FIGS. 6A to 6C) may be scrambled with a virtual identity of the one virtual NTN device. In some embodiments, the virtual identity may be specific to the given geographic area, in order to provide “transparency” service for terminal devices located in a given geographic area. As discussed the above, the identity information obtained by the terminal devices may include one or more virtual identities of one or more virtual NTN devices, so that the terminal device may use the virtual identity to receive, detect and measure the respective reference signals.

In some embodiments, the virtual NTN may transmit all of those beams in different time and/or frequency resources. If the virtual NTN were to transmit all beams (e.g., all three beams) in the same time and frequency resources, it may result in very high inter-beam interference. This would negatively impact the signal quality on the ground. The terminal devices may be able to receive reference signals transmitted using those beams, however they may not be able to detect and measure those reference signals as the signal quality would be below a threshold where detection and measurement would be possible. As similarly to the above beam hopping embodiments, separating the transmission of beams in the time and/or frequency domain would allow the virtual NT-TRP to transmit beams in a way that results in lower inter-beam interference. Such schemes may be called “beam hopping schemes”.

FIG. 6D illustrates another example of virtual NTN devices formed by one or more actual NT-TRPs and virtual identities of the virtual NT-TRPs that are used for reference signals in a corresponding geographic area according to some embodiments of the present disclosure. In FIG. 6D, without any limitation, assuming that a “virtual array” of satellites (which is represented by the reference number 640) provides a coverage on terminal devices for the given area (i.e, coverage area ID=2) on the ground, and another “virtual array” of satellites (which is represented by the reference number 650) provides a coverage on terminal devices for the given area (i.e, coverage area ID=3) on the ground.

As shown in FIG. 6D, the NTN devices in one dash block may constitute a respective virtual NTN device. Thus, FIG. 6D shows two virtual NTN devices. For example, the NTN devices in block 640 may constitute a first virtual NTN device 640, and the NTN devices in block 650 may constitute a second virtual NTN device 650.

In some embodiments, the NTN devices (or NT-TRPs) that constitute a given virtual NTN device (or virtual NT-TRP) may change over the time. That is, at least one member or the number of members in the set of NTN devices may be changed over the time. A given NTN device may belong to one virtual NTN device at one point in time, and belong to another virtual NTN device at another point in time. As an example, the NTN device 660 may belong to the virtual NTN device 640 that provides the coverage for the geographic area having the coverage area ID=2 at first. Then, the NTN device 660 may move along the orbit over the time. Then, the NTN device 660 does not belong to the virtual NTN device 640, and transitions to belong to the virtual NTN device 660 that provides the coverage for the geographic area having the coverage area ID=3.

In addition or alternatively, the reason of the changing of NTN device between virtual NTN devices may be that different geographic areas may have different sizes, a large geographic area may not require a large amount of beamforming and may be covered by using a wide beam, whereas a small geographic may require a large amount of beamforming and may be covered by using a narrow beam. As a result, in terms of the constituting the virtual NTN device, the size of a virtual NTN device (i.e., the number of NTN devices forming the virtual NTN device) may change over time, however this doesn't necessarily imply that the virtual NT-TRP's identity changes over time. In some embodiments of this disclosure, the virtual NT-TRP's identity may be denoted as n_{VID}.

In some embodiments, the virtual identity (which may be also referred to virtual NT-TRP identity) of the virtual NTN device may be used in the equation of the scrambling identity of reference signals such as NZP CSI-RS, such that the terminal devices within a coverage area may receive, detect and measure these reference signals, an example of this equation is provided below (assuming NZP CSI-RS):

$${c}_{init} = ( {2}^{10} ( {N}_{symb}^{slot} {n}_{s , f}^{μ} + l + 1 ) ( 2 {n}_{VId} + 1 ) + {n}_{VId} ) mod {2}^{31} \qquad ( 5 )$$

where

$${N}_{symb}^{slot}$$

designates the number or OFDM symbols per slot,

$${n}_{s , f}^{μ}$$

designates the slot number within a given radio frame, l designates the OFDM symbol number within a slot and n_{VId} designates the virtual identity.

In addition or alternatively, the virtual identity may be used in the equation of the scrambling identity of reference signals such as synchronization signals, such that terminal devices within a coverage area may receive, detect and measure these synchronization signals (for example, PSS), an example of this equation is provided below:

$${d}_{PSS} ( n ) = 1 - 2 x ( m ) \qquad ( 6 )$$

$$m = ( n + {An}_{VId} ) mod 255$$

$$A > 0$$

$$0 \leq n < 255$$

$$x ( i + 7 ) = ( x ( i + 4 ) + x ( i ) ) mod 2$$

$$[ x ( 6 ) x ( 5 ) x ( 4 ) x ( 3 ) x ( 2 ) x ( 1 ) x ( 0 ) ] = [ 10001000 ]$$

where d_{PSS} denotes the binary sequence of length 256 used by the PSS; m and n are both integer values between 0 and 255; A is an integer value higher than 0; and n_{VId} denotes the virtual identity.

In some embodiments, the virtual NTN device may be formed by NTN devices that belong to the same orbit within the same constellation. One of the benefits of using NTN devices (that belong to the same orbit within the same constellation) to form virtual NTN device is that NTN devices that belong to the same orbit don't move relative to each-other as they follow the same trajectory and have the same speed. This makes it easier to dynamically/semi-statically coordinate NT-TRPs to form virtual NT-TRPs and switch one NT-TRP from one virtual NT-TRP to another virtual NT-TRP. Such capability may depend on the NT-TRP's capability to communicate with NT-TRPs located in the same orbit using e.g. inter-satellite links (ISLs). In some embodiments, virtual NT-TRPs may be formed using NT-TRPs that belong to adjacent orbits within the same constellation. One of the benefits of using NT-TRPs (that belong to adjacent orbits within the same constellation) to form virtual NT-TRPs is that NT-TRPs may be used opportunistically to form virtual NT-TRPs to help improve coverage and beamforming performance. Such capability may depend on the NT-TRP's capability to communicate with NT-TRPs located in adjacent orbits using e.g. inter-satellite links (ISLs). Inter-satellite links may be based on e.g. free space optics (FSO).

In view of the above, one of the benefits of using such virtual NT-TRP identities is that it enables network transparency. It should be noted that such changes in the virtual NT-TRPs may be transparent as far as devices on the ground are concerned, as the virtual NT-TRPs' identities would not be changing. If the virtual NT-TRPs' identities don't change, then as far as devices on the ground are concerned: they may continue to receive, detect and measure reference signals based on the scrambling identities that are using the virtual NT-TRP identity.

Referring back to FIG. 3, in some embodiments, if the terminal device 110 completes the Initial Access Procedure, the terminal device 110 may transition (335) to the connected mode. In some embodiments, in the case that the terminal device in the connected mode communicates with NTN, the associated reference signals may be further scrambled with a terminal device-specific scrambling identity (which may be also referred to as “UE-specific scrambling identity”). In some embodiments, the terminal device 110 may obtain (340) a terminal device-specific scrambling identity. For example, the terminal device-specific scrambling identity may be provided to the terminal device 110 as part of higher-layer signaling such as e.g. RRC. There may be several benefits from providing UE-specific scrambling identities, mainly in terms of enabling user-centric designs. To discuss clarity, the reference signals scrambled by the terminal device-specific scrambling identity is further discussed with reference to FIG. 7.

FIG. 7 illustrates an example of a terminal device-specific scrambling identity used to scramble the reference signals in the connected mode of a terminal device according to some embodiments of the present disclosure.

As shown in FIG. 7, assuming that three geographic areas (or coverage areas) are defined on the ground, and each coverage area has a corresponding geographic area identity and one location-specific scrambling identity denoted as n_{cAId}, as discussed in FIGS. 4A to 4D. Assuming that the terminal device 110 may perform the Initial Access Procedure based on the geographic area identity and one location-specific scrambling identity. How to scramble the reference signals and receive the respective reference signals is mainly discussed in the embodiments related to FIGS. 4A to 4D, and these embodiments are not further discussed here. In addition or alternatively, the terminal device 110 may also perform the Initial Access Procedure based on the above beam identity-related information and/or virtual NTN identity, without any limitation.

In some embodiments, assuming that the terminal device 110 has completed Initial Access with the non-terrestrial TRPs and has established an RRC connection with one of the non-terrestrial TRPs. The terminal device 110 are now in so-called connected mode and can be sent higher-layer signaling (i.e. RRC signaling) carrying UE-specific signaling information. In some embodiments, the terminal device 110 may be configured with terminal device-specific scrambling identities (or UE-specific scrambling identity), which can be used by the terminal device 110 to receive, detect and measure reference signals whose PRN binary sequences were generated using those UE-specific scrambling identities. As an example, the terminal device 110 may be configured using higher-layer signaling (e.g. RRC) to receive, detect and measure reference signals whose PRN binary sequence may be initialized using both location-specific scrambling IDs and terminal-specific IDs with the following equation:

$${c}_{init} = ( {2}^{10} ( {N}_{symb}^{slot} {n}_{s , f}^{μ} + l + 1 ) ( 2 {n}_{CAId} + 1 ) ( 2 {n}_{UEId} + 1 ) + {n}_{CAId} + {n}_{UEId} ) mod {2}^{31} \qquad ( 7 )$$

where

$${N}_{symb}^{slot}$$

designates the number OF OFDM symbols per slot,

$${n}_{s , f}^{μ}$$

designates the slot number within a given radio frame, l designates the OFDM symbol number within a slot, n_{CAId} designates the location-specific scrambling identity and n_{uEId} designates the terminal device-specific scrambling identity. The terminal device-specific scrambling identity may be an integer value higher than zero configured to the UE using higher-layer signaling (e.g. RRC). Taking the geographic areas in FIG. 7 as an example, for a given geographic area, the reference signals may be scrambled by coverage area scrambling ID “n_{cAId}=14” and UE-specific scrambling ID “n_{UEId}=389”. The reference signals for other geographic areas may be scrambled similarly.

In another example, the terminal device 110 may be configured using higher-layer signaling (e.g. RRC) to receive, detect and measure reference signals whose PRN binary sequence may be initialized using the terminal device-specific IDs with the following equation:

$${c}_{init} = ( {2}^{10} ( {N}_{symb}^{slot} {n}_{s , f}^{μ} + l + 1 ) ( 2 {n}_{UEId} + 1 ) + {n}_{CAId} + {n}_{UEId} ) ) mod {2}^{31} \qquad ( 8 )$$

where

$${N}_{symb}^{slot}$$

designates the number of OFDM symbols per slot,

$${n}_{s , f}^{μ}$$

designates the slot number within a given radio frame, l designates the OFDM symbol number within a slot and nuEla designates the terminal device-specific identity (ID).

One of the benefits of providing the terminal device-specific scrambling identities is that it allows for user-centric design. Devices such as e.g. UEs, IoT devices, cars, and so on, are looking for reference signals whose PRN binary sequence is generated based on their UE-specific scrambling identity. As an example, the reference signals may be transmitted by non-terrestrial TRPs such as satellites. As shown in FIG. 3, the NTN device 172 may transmit (350) reference signals 355 that are initiated using the terminal device-specific scrambling identity. Accordingly, the terminal device 110 may receive (360) the reference signals 355 using the terminal device 110's terminal device-specific scrambling identity.

As shown in FIG. 7, a given terminal device is configured with the terminal-specific scrambling ID set to 389, this may allow the terminal device to receive, detect and measure reference signals (such as e.g. NZP CSI-RS) that are initialized using this terminal-specific scrambling ID=389. Similarly, another given terminal device is configured with the terminal device-specific scrambling ID set to 591, this may allow the other given terminal device to receive, detect and measure reference signals (such as e.g. NZP CSI-RS) that are initialized using that terminal device-specific scrambling ID=591. Similarly, a further given terminal device is configured with the UE-specific scrambling ID set to 702, this may allow the further terminal device to receive, detect and measure reference signals (such as e.g. NZP CSI-RS) that are initialized using that UE-specific scrambling ID=702. The dashed line depicts a given coverage area, as they were defined in the previous embodiment. In addition, it should be understood that these reference signals may be transmitted by any of the non-terrestrial NTN devices, which is a reflection of the network transparency. For example, any one of the non-terrestrial NTN devices may send the reference signal that the terminal device is configured to receive, detect and measure.

In some embodiments, the NTN device 172 may transmit reference signals whose PRN binary sequence may be generated based on so-called “beam-specific” scrambling identities. An example of such beam-specific scrambling identities may be e.g. “Physical Beam Identities” as shown in e.g. FIG. 5C. Denoting the beam-specific scrambling identity as n_{BeamSpecificID}, the UE may have a pseudo-random sequence generator which may be initialized with a beam-specific scrambling identity as follows:

$${c}_{init} = ( {2}^{10} ( {N}_{symb}^{slot} {n}_{s , f}^{μ} + l + 1 ) ( 2 {n}_{BeamSpecificId} + 1 ) + {n}_{BeamSpecificId} ) mod {2}^{31}$$

In some embodiments, the scrambling identities used to initialize a reference signal such as e.g. SS/PBCH block or NZP CSI-RS may be equivalently called a “seed”. Such seeds may be used by a UE to initialize the pseudo-random sequence generator and generate the corresponding reference signal.

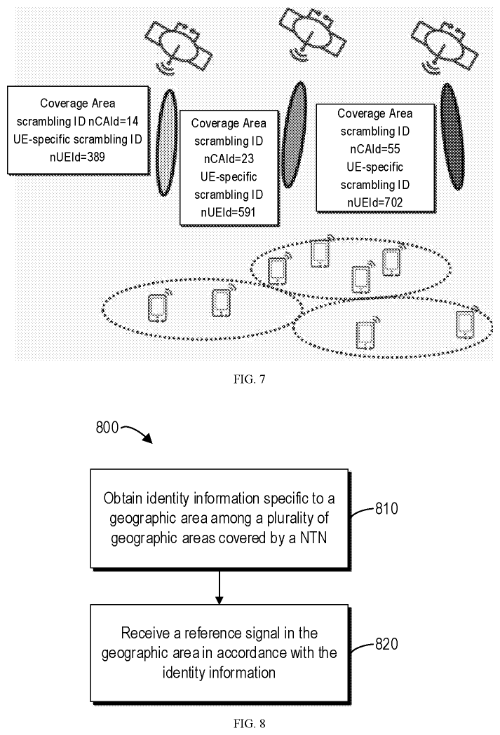

FIG. 8 illustrates a flowchart of a method 800 of communication implemented at a terminal device in accordance with some embodiments of the present disclosure. The method 800 can be implemented at the terminal device 110 shown in FIG. 1A. For the purpose of discussion, the method 800 will be described with reference to FIG. 1A. It is to be understood that the method 800 may include additional acts not shown and/or may omit some shown acts, and the scope of the present disclosure is not limited in this regard.

At 810, the terminal device 110 obtains identity information specific to a geographic area among a plurality of geographic areas covered by a NTN. At 820, the terminal device 110 receives a reference signal in the geographic area in accordance with the identity information. It should be noted that the method 800 may include various other operations which may be performed by the terminal device 110 as described above with reference to the signaling process 300 of FIG. 3.

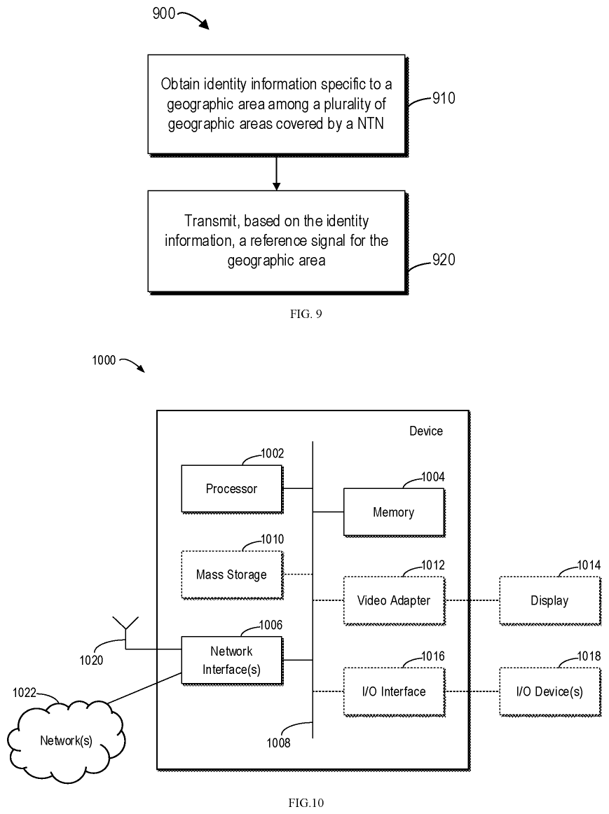

FIG. 9 illustrates a flowchart of a method 900 of communication implemented at a NTN device in accordance with some embodiments of the present disclosure. The method 900 can be implemented at the NT-TRP 172 shown in FIG. 1B. For the purpose of discussion, the method 900 will be described with reference to FIG. 1B. It is to be understood that the method 900 may include additional acts not shown and/or may omit some shown acts, and the scope of the present disclosure is not limited in this regard.

At 910, the NTN device 172 obtains identity information specific to a geographic area among a plurality of geographic areas covered by a NTN. At 920, the NTN device 172 transmits, based on the identity information, a reference signal for the geographic area. It should be noted that the method 900 may include various other operations which may be performed by the second device 170 as described above with reference to the signaling process 300 of FIG. 3.

FIG. 10 is a block diagram of a device 1000 that may be used for implementing some embodiments of the present disclosure. In some embodiments, the device 1000 may be an element of communications network infrastructure, such as a base station (for example, a NodeB, an evolved Node B (eNodeB, or eNB), a next generation NodeB (sometimes referred to as a gNodeB or gNB), a home subscriber server (HSS), a gateway (GW) such as a packet gateway (PGW) or a serving gateway (SGW) or various other nodes or functions within a core network (CN) or a Public Land Mobility Network (PLMN). In other embodiments, the device 1000 may be a device that connects to the network infrastructure over a radio interface, such as a mobile phone, smart phone or other such device that may be classified as a User Equipment (UE). In some embodiments, the device 1000 may be a Machine Type Communications (MTC) device (also referred to as a machine-to-machine (M2M) device), or another such device that may be categorized as a UE despite not providing a direct service to a user. In some embodiments, the device 1000 may be a road side unit (RSU), a vehicle UE (V-UE), pedestrian UE (P-UE) or an infrastructure UE (I-UE). In some scenarios, the device 1000 may also be referred to as a mobile device, a term intended to reflect devices that connect to mobile network, regardless of whether the device itself is designed for, or capable of, mobility. Specific devices may utilize all of the components shown or only a subset of the components, and levels of integration may vary from device to device. Furthermore, the device 1000 may contain multiple instances of a component, such as multiple processors, memories, transmitters, receivers, etc.

The device 1000 typically includes a processor 1002, such as a Central Processing Unit (CPU), and may further include specialized processors such as a Graphics Processing Unit (GPU) or other such processor, a memory 1004, a network interface 1006 and a bus 1008 to connect the components of the device 1000. The device 1000 may optionally also include components such as a mass storage device 1010, a video adapter 1012, and an I/O interface 1016 (shown in dashed lines).

The memory 1004 may comprise any type of non-transitory system memory, readable by the processor 1002, such as static random access memory (SRAM), dynamic random access memory (DRAM), synchronous DRAM (SDRAM), read-only memory (ROM), or a combination thereof. In an embodiment, the memory 1004 may include more than one type of memory, such as ROM for use at boot-up, and DRAM for program and data storage for use while executing programs. The bus 1008 may be one or more of any type of several bus architectures including a memory bus or memory controller, a peripheral bus, or a video bus.

The device 1000 may also include one or more network interfaces 1006, which may include at least one of a wired network interface and a wireless network interface. As illustrated in FIG. 10, network interface 1006 may include a wired network interface to connect to a network 1022, and also may include a radio access network interface 1020 for connecting to other devices over a radio link. When the device 1000 is a network infrastructure element, the radio access network interface 1020 may be omitted for nodes or functions acting as elements of the PLMN other than those at the radio edge (e.g., an eNB). When the device 1000 is infrastructure at the radio edge of a network, both wired and wireless network interfaces may be included. When the device 1000 is a wirelessly connected device, such as a User Equipment, radio access network interface 1020 may be present and it may be supplemented by other wireless interfaces such as WiFi network interfaces. The network interfaces 1006 allow the device 1000 to communicate with remote entities such as those connected to network 1022.

The mass storage 1010 may comprise any type of non-transitory storage device configured to store data, programs, and other information and to make the data, programs, and other information accessible via the bus 1008. The mass storage 1010 may comprise, for example, one or more of a solid state drive, hard disk drive, a magnetic disk drive, or an optical disk drive. In some embodiments, the mass storage 1010 may be remote to the device 1000 and accessible through use of a network interface such as interface 1006. In the illustrated embodiment, the mass storage 1010 is distinct from memory 1004 where it is included, and may generally perform storage tasks compatible with higher latency, but may generally provide lesser or no volatility. In some embodiments, the mass storage 1010 may be integrated with a heterogeneous memory 1004.

The optional video adapter 1012 and the I/O interface 1016 (shown in dashed lines) provide interfaces to couple the device 1000 to external input and output devices. Examples of input and output devices include a display 1014 coupled to the video adapter 1012 and an I/O device 1018 such as a touch-screen coupled to the I/O interface 1016. Other devices may be coupled to the device 1000, and additional or fewer interfaces may be utilized. For example, a serial interface such as Universal Serial Bus (USB) (not shown) may be used to provide an interface for an external device. Those skilled in the art will appreciate that in embodiments in which the device 1000 is part of a data center, I/O interface 1016 and Video Adapter 1012 may be virtualized and provided through network interface 1006.

FIG. 11 is a schematic diagram of a structure of an apparatus 1100 in accordance with some embodiments of the present disclosure. As shown in FIG. 11, the apparatus 1100 includes an obtaining unit 1102 and a receiving unit 1104. The apparatus 1100 may be applied to the communication system as shown in FIGS. 1A to 1E, and may implement any of the methods provided in the foregoing embodiments. Optionally, a physical representation form of the apparatus 1100 may be a communication device, for example, a network device or UE. Alternatively, the apparatus 1100 may be another apparatus that can implement a function of a communication device, for example, a processor or a chip inside the communication device. Specifically, the apparatus 1100 may be some programmable chips such as a field-programmable gate array (FPGA), a complex programmable logic device (CPLD), an application-specific integrated circuit (ASIC), or a system on a chip (SOC).

In some embodiments, the obtaining unit 1102 may be configured to obtain identity information specific to a geographic area among a plurality of geographic areas covered by a non-terrestrial network (NTN). In some embodiments, the receiving unit 1104 may be configured to receive a reference signal in the geographic area in accordance with the identity information. In some other embodiments, the apparatus 1100 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor to perform all or some of the steps of the methods described in embodiments of the present disclosure. The foregoing storage medium includes any medium that can store program code, such as a USB flash drive, a removable hard disk, a read-only memory (ROM), a random access memory (RAM), a magnetic disk, or an optical disc.

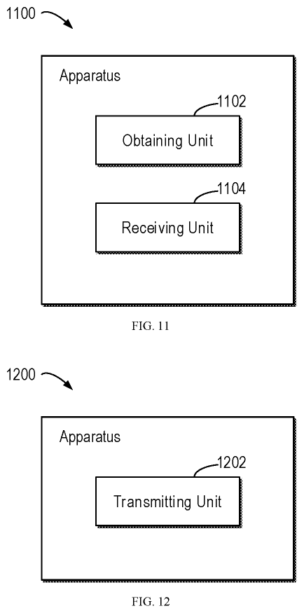

FIG. 12 is a schematic diagram of a structure of an apparatus 1200 in accordance with some embodiments of the present disclosure. As shown in FIG. 12, the apparatus 1200 includes a transmitting unit 1202. The apparatus 1200 may be applied to the communication system as shown in FIGS. 1A to 1E, and may implement any of the methods provided in the foregoing embodiments. Optionally, a physical representation form of the apparatus 1200 may be a communication device, for example, a network device. Alternatively, the apparatus 1200 may be another apparatus that can implement a function of a communication device, for example, a processor or a chip inside the communication device. Specifically, the apparatus 800 may be some programmable chips such as a field-programmable gate array (FPGA), a complex programmable logic device (CPLD), an application-specific integrated circuit (ASIC), or a system on a chip (SOC).

In some embodiments, the transmitting unit 1202 may be configured to transmit, based on identity information, a reference signal for a geographic area among a plurality of geographic areas covered by a non-terrestrial network (NTN), wherein the identity information is specific to the geographic area. In some other embodiments, the apparatus 1200 can include various other units or modules which may be configured to perform various operations or functions as described in connection with the foregoing method embodiments. The details can be obtained referring to the detailed description of the foregoing method embodiments and are not described herein again.

It should be noted that division into the units or modules in the foregoing embodiments of the present disclosure is an example, and is merely logical function division. In actual implementation, there may be another division manner. In addition, function units in embodiments of the present disclosure may be integrated into one processing unit, or may exist alone physically, or two or more units may be integrated into one unit. The integrated unit may be implemented in a form of hardware, or may be implemented in a form of a software function unit.

When the integrated unit is implemented in a form of a software function unit and sold or used as an independent product, the integrated unit may be stored in a computer-readable storage medium. Based on such an understanding, the technical solutions of the present disclosure essentially, or all or some of the technical solutions may be implemented in a form of a software product. The computer software product is stored in a storage medium and includes several instructions for instructing a computer device (which may be a personal computer, a server, or a network device) or a processor to perform all or some of the steps of the methods described in embodiments of the present disclosure. The foregoing storage medium includes any medium that can store program code, such as a USB flash drive, a removable hard disk, a read-only memory (ROM), a random access memory (RAM), a magnetic disk, or an optical disc.

In some aspects of the present disclosure, there is provided a computer program comprising instructions. The instructions, when executed by a processor, may cause the processor to implement a method of the present disclosure.

In some aspects of the present disclosure, there is provided a non-transitory computer-readable medium storing instructions, the instructions, when executed by a processor, may cause the processor to implement a method of the present disclosure.

The solutions described in the disclosure is applicable to a next generation (e.g. sixth generation (6G) or later) network, or a legacy (e.g. 5G, 4G, 3G or 2G) network.

It will be appreciated that any module, component, or device disclosed herein that executes instructions may include, or otherwise have access to, a non-transitory computer/processor readable storage medium or media for storage of information, such as computer/processor readable instructions, data structures, program modules and/or other data. A non-exhaustive list of examples of non-transitory computer/processor readable storage media includes magnetic cassettes, magnetic tape, magnetic disk storage or other magnetic storage devices, optical disks such as compact disc read-only memory (CD-ROM), digital video discs or digital versatile discs (i.e., DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device/apparatus or accessible or connectable thereto. Computer/processor readable/executable instructions to implement a method, an application or a module described herein may be stored or otherwise held by such non-transitory computer/processor readable storage media.

It could be noted that the message in the disclosure could be replaced with information, which may be carried in one single message, or be carried in more than one separate message.

Without special noting, the terms “apparatus” and “device” are used interchangeably, and the terms “identity” and “identifier” are used interchangeably.

In the disclosure, the word “a” or “an” when used in conjunction with the term “comprising” or “including” in the claims and/or the specification may mean “one”, but it is also consistent with the meaning of “one or more”, “at least one”, and “one or more than one” unless the content clearly dictates otherwise. Similarly, the word “another” may mean at least a second or more unless the content clearly dictates otherwise.

In the disclosure, the words “first”, “second”, etc., when used before a same term (e.g., ED, or an operating step) does not mean an order or a sequence of the term. For example, the “first ED” and the “second ED”, means two different EDs without specially indicated, and similarly, although the present disclosure describes methods and processes with steps in a certain order, one or more steps of the methods and processes may be omitted or altered as appropriate. One or more steps may take place in an order other than that in which they are described, as appropriate. For example, the “first step” and the “second step” means two different operating steps without specially indicated, but does not mean the first step have to happen before the second step. The real order depends on the logic of the two steps.

The terms “coupled”, “coupling” or “connected” as used herein can have several different meanings depending on the context in which these terms are used. For example, as used herein, the terms coupled, coupling, or connected can indicate that two elements or devices are directly connected to one another or connected to one another through one or more intermediate elements or devices via a mechanical element depending on the particular context.

Note that the expression “at least one of A or B”, as used herein, is interchangeable with the expression “A and/or B”. It refers to a list in which you may select A or B or both A and B. Similarly, “at least one of A, B, or C”, as used herein, is interchangeable with “A and/or B and/or C” or “A, B, and/or C”. It refers to a list in which you may select: A or B or C, or both A and B, or both A and C, or both B and C, or all of A, B and C. The same principle applies for longer lists having a same format.

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

The term “receive”, “detect” and “decode” as used herein can have several different meanings depending on the context in which these terms are used. For example, without special note, the term “receive” may indicate that information (e.g., DCI, or MAC-CE, RRC signaling or TB) is received successfully by the receiving node, which means the receiving side correctly detect and decode it. In this scenario, “receive” may cover “detect” and “decode” or may indicates same thing, e.g., “receive paging” means decoding paging correctly and obtaining the paging successfully, accordingly, “the receiving side does not receive paging” means the receiving side does not detect and/or decoding the paging. “paging is not received” means the receiving side tries to detect and/or decoding the paging, but not obtain the paging successfully. The term “receive” may sometimes indicate that a signal arrives at the receiving side, but does not mean the information in the signal is detected and decoded correctly, then the receiving side need perform detecting and decoding on the signal to obtain the information carried in the signal. In this scenario, “receive”, “detect” and “decode” may indicate different procedure at receiving side to obtain the information.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description. When combining two or more embodiments, not all the features in the embodiments to be combined are necessary for the combination.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

What is claimed is:

1. A method performed at a terminal device, comprising:
obtaining identity information specific to a geographic area among a plurality of geographic areas covered by a non-terrestrial network (NTN); and
receiving a reference signal in the geographic area in accordance with the identity information.

2. The method of claim 1, wherein the identity information is comprised in geographic area information, wherein the geographic area information is a portion of an elementary file, and wherein the identity information indicates:
a plurality of geographic area identities that identify the plurality of geographic areas, and
a plurality of location-specific scrambling identity values corresponding to the plurality of geographic area identities.

3. The method of claim 2, wherein the reference signal is scrambled with a location-specific scrambling identity value that corresponds to a target geographic area identity identifying the geographic area, and wherein the receiving the reference signal comprises:
determining the target geographic area identity from the plurality of geographic area identities, wherein the target geographic area identity identifies a target geographic area in which the terminal device is located; and
receiving the reference signal using the location-specific scrambling identity value of the plurality of location-specific scrambling identity values which corresponds to the target geographic area identity.

4. The method of claim 2, wherein the geographic area information indicates at least one of:
a number of slots within a radio frame;
a slot in which the reference signal is transmitted;
a number of symbols within the slot; or
an index for a symbol.

5. The method of claim 2, wherein the elementary file further comprises timing reference information, and the timing reference information indicates at least one of:
reference time,
a system frame number,
a radio frame number,
a slot number, or
a symbol number.

6. The method of claim 1, wherein the identity information comprises a plurality of beam set identities, and a plurality of beam identities associated with a beam set identity of the plurality of beam set identities.

7. The method of claim 6, wherein the reference signal comprises a primary synchronization signal (PSS) and a secondary synchronization signal (SSS), and wherein:
the PSS transmitted via a first beam is determined based on the beam set identity; and
the SSS transmitted via the first beam is determined based on a first beam identity.

8. The method of claim 6, wherein the reference signal comprises a PSS and a SSS, and wherein the receiving the reference signal comprises:
receiving the PSS using the plurality of beam set identities; and
receiving the SSS using the plurality of beam identities.

9. The method of claim 6, wherein beams from the NTN are divided into a plurality of beam subsets, and wherein at least one of:
activated beams are hopped between the plurality of beam subsets in order to mitigate inter-beam interference;
a beam subset of the plurality of beam subsets is associated with a geographic area identity identifying the geographic area; or
the beam subset is associated with a physical identity of a beam.

10. A method performed at a non-terrestrial network (NTN) device, comprising:
obtaining identity information specific to a geographic area among a plurality of geographic areas covered by a non-terrestrial network (NTN); and
transmitting, based on the identity information, a reference signal for the geographic area.

11. The method of claim 10, wherein the identity information is comprised in geographic area information, wherein the geographic area information is a portion of an elementary file, and wherein the identity information indicates:
a plurality of geographic area identities that identify the plurality of geographic areas, and
a plurality of location-specific scrambling identity values corresponding to the plurality of geographic area identities.

12. The method of claim 11, wherein the reference signal is scrambled with a location-specific scrambling identity value that corresponds to a target geographic area identity identifying the geographic area.

13. The method of claim 11, wherein the geographic area information indicates at least one of:
a number of slots within a radio frame;
a slot in which the reference signal is transmitted;
a number of symbols within the slot; or
an index for a symbol.

14. The method of claim 11, wherein the elementary file further comprises timing reference information, and the timing reference information indicates at least one of:
reference time,
a system frame number,
a radio frame number,
a slot number, or
a symbol number.

15. The method of claim 10, wherein the method further comprises:
transmitting, to a terminal device in a connected-mode, a terminal device-specific scrambling identity of the terminal device.

16. The method of claim 15, wherein the reference signal towards the terminal device is scrambled with the terminal device-specific scrambling identity.

17. The method of claim 15, wherein:
a physical identity of a first beam is determined based on a first beam set identity of a plurality of beam set identities and a first beam identity of a first plurality of beam identities associated with the first beam set identity,
a first beam set identified by the first beam set identity comprises the first beam, and
the physical identity is used by the terminal device to identify the first beam at a physical layer.

18. The method of claim 17, wherein the reference signal comprises a primary synchronization signal (PSS) and a secondary synchronization signal (SSS), and wherein:
the PSS transmitted via the first beam is determined based on the first beam set identity; and
the SSS transmitted via the first beam is determined based on the first beam identity.

19. The method of claim 17, wherein the first beam comprises a transmit beam of the NTN.

20. The method of claim 17, wherein beams transmitted by the NTN are divided into a plurality of beam subsets, and wherein at least one of:
activated beams are hopped between the plurality of beam subsets in order to mitigate inter-beam interference;
a beam subset of the plurality of beam subsets is associated with a geographic area identity identifying the geographic area; or
the beam subset is associated with the physical identity of the first beam.
